(19) United States
(12) Patent Application Publication
(10) Pub. No.: US 2025/0022039 A1
(43) Pub. Date: Jan. 16, 2025

(54) CONTROL SYSTEM, CONTROL METHOD, AND RECORDING MEDIUM

(71) Applicant: NEC Corporation, Minato-ku, Tokyo (JP)

(72) Inventors: Rumi IKEZAWA, Tokyo (JP); Tadamasa Yokoyama, Tokyo (JP)

(73) Assignee: NEC Corporation, Minato-ku, Tokyo (JP)

(21) Appl. No.: 18/712,030

(22) PCT Filed: Dec. 16, 2021
(86) PCT No.: PCT/JP2021/046450

§ 371 Date: May 21, 2024

(51) Int. Cl. G06Q 30/0601; G06K 7/14

(52) U.S. Cl. CPC G06Q 30/0633; G06K 7/1413; G06Q 30/0641

(57) ABSTRACT

This control system including: a registration unit configured to register, when identification information is read on a reading screen capable of reading the identification information about a product by an operation by a customer on the terminal device, the product indicated by identification information in a list; a mode reception unit configured to receive one of a sequential checking mode in which a list screen of the list is displayed when the identification information is read and a continuous mode in which the reading screen is displayed when the identification information is read; and a display control unit configured to display a screen related to the received mode on the terminal device.

### TECHNICAL FIELD

The present disclosure relates to a control system and the like.

### BACKGROUND ART

There is scan shopping for registering a product on a terminal device by an operation by a customer.

For example, PTL 1 describes that a portable terminal device scans a barcode attached to a product and reads the product code. Then, for example, PTL 1 describes a technique in which cart identification information and a product code are transmitted to a transaction management device, the transaction management device identifies cart information about the transaction by the cart identification information, and updates product data in the identified cart information.

### CITATION LIST

### Patent Literature

PTL 1: JP 2021-128363 A

### SUMMARY OF INVENTION

### Technical Problem

However, when the identification information about the product is read, some customers may want to continuously read the product information, or other customers may want to check the registered product every time the product is read. For example, when the operation of the terminal device operated by the customer is uniquely determined, the customer may feel inconvenient to operate the terminal device at the time of shopping.

An object of the present disclosure is to provide a control system and the like that can improve convenience at the time of shopping.

### Solution to Problem

A control system according to an aspect of the present disclosure includes a registration means that registers, when identification information is read on a reading screen capable of reading the identification information about a product by an operation by a customer on the terminal device, the product indicated by identification information in a list, a mode reception means that receives one of a sequential checking mode in which a list screen of the list is displayed when the identification information is read and a continuous mode in which the reading screen is displayed when the identification information is read, and a display control means that displays a screen related to the received mode on the terminal device.

A control method according to an aspect of the present disclosure is a control method of controlling a screen to be displayed by a terminal device, the control method includes registering, when identification information is read on a reading screen capable of reading the identification information about a product by an operation by a customer on the terminal device, the product indicated by identification information in a list, receiving one of a sequential checking mode in which a list screen of the list is displayed when the identification information is read and a continuous mode in which the reading screen is displayed when the identification information is read, and displaying a screen related to the received mode on the terminal device.

A program according to an aspect of the present disclosure causes a computer controlling a screen to be displayed by a terminal device to execute the steps of registering, when identification information is read on a reading screen capable of reading the identification information about a product by an operation by a customer on the terminal device, the product indicated by identification information in a list, receiving one of a sequential checking mode in which a list screen of the list is displayed when the identification information is read and a continuous mode in which the reading screen is displayed when the identification information is read, and displaying a screen related to the received mode on the terminal device.

The program may be stored in a non-transitory computer-readable recording medium.

### Advantageous Effects of Invention

According to the present disclosure, it is possible to improve convenience at the time of shopping.

### BRIEF DESCRIPTION OF DRAWINGS

FIG. 1 is a block diagram illustrating a configuration example of a control system according to the first example embodiment.

FIG. 2 is a flowchart illustrating an operation example of the control system according to the first example embodiment.

FIG. 3 is an explanatory diagram illustrating an example of connection between a control system and each device according to the second example embodiment.

FIG. 4 is a block diagram illustrating a configuration example of a control system according to the second example embodiment.

FIG. 5 is a block diagram illustrating a configuration example of a terminal device according to the second example embodiment.

FIG. 6 is an explanatory diagram illustrating an example of receiving a mode.

FIG. 7 is an explanatory diagram illustrating an example of screen transition of a terminal device in a sequential checking mode.

FIG. 8 is an explanatory diagram illustrating another example of the reading screen in the sequential checking mode.

FIG. 9 is an explanatory diagram illustrating an example of screen transition in a continuous scan mode.

FIG. 10 is an explanatory diagram illustrating an example of a list screen in the continuous scan mode.

FIG. 11 is an explanatory diagram illustrating another example of a reading screen in the continuous scan mode.

FIG. 12 is an explanatory diagram illustrating an example of receiving a mode during display of a reading screen.

FIG. 13 is an explanatory diagram illustrating an example in which a screen for receiving a mode is superimposed and displayed on a reading screen.

FIG. 14 is a flowchart illustrating an operation example of the control system according to the second example embodiment.

FIG. 15 is a flowchart illustrating an example of a specific processing procedure of a process before product registration (step S201) by the control system.

FIG. 16 is a flowchart illustrating an example of a specific processing procedure of a process of the sequential checking mode (step S204) by the control system.

FIG. 17 is a flowchart illustrating an example (part 1) of a specific processing procedure of a process of the continuous scan mode (step S203) by the control system.

FIG. 18 is a flowchart illustrating an example (part 2) of a specific processing procedure of a process of the continuous scan mode (step S203) by the control system.

FIG. 19 is a flowchart illustrating an example of a specific processing procedure of a process before product registration (step S211) by the terminal device.

FIG. 20 is a flowchart illustrating an example (part 1) of a specific processing procedure of a process of the sequential checking mode (step S214) by the terminal device.

FIG. 21 is a flowchart illustrating an example (part 2) of a specific processing procedure of a process of the sequential checking mode (step S214) by the terminal device.

FIG. 22 is a flowchart illustrating an example (part 1) of a specific processing procedure of a process of the continuous scan mode (step S213) by the terminal device.

FIG. 23 is a flowchart illustrating an example (part 2) of a specific processing procedure of a process of the continuous scan mode (step S213) by the terminal device.

FIG. 24 is a flowchart illustrating an example of a specific processing procedure of the processing example 1 of the control system determining whether the operation is suspicious.

FIG. 25 is a flowchart illustrating an example of a specific processing procedure of the processing example 2 of the control system determining whether the operation is suspicious.

FIG. 26 is a flowchart illustrating an example of a specific processing procedure of the processing example 3 of the control system determining whether the operation is suspicious.

FIG. 27 is a flowchart illustrating an example of a specific processing procedure of the processing example 4 of the control system determining whether the operation is suspicious.

FIG. 28 is an explanatory diagram illustrating a hardware configuration example of a computer device.

### EXAMPLE EMBODIMENT

Hereinafter, example embodiments of a control system, a control method, a program, and a non-transitory recording medium recording the program according to the present disclosure will be described in detail with reference to the drawings. The present example embodiment does not limit the disclosed technology.

### First Example Embodiment

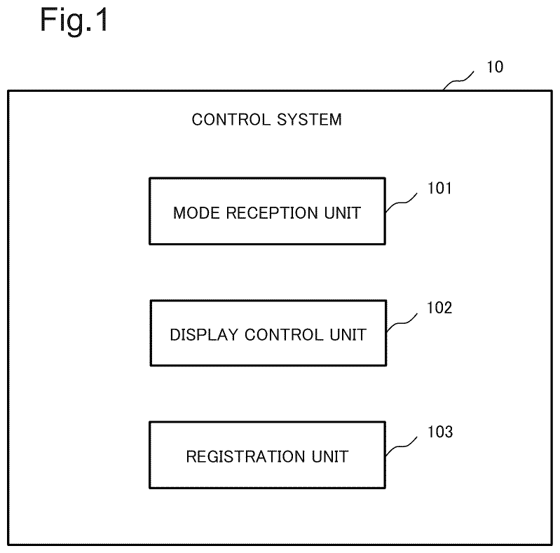

First, in the first example embodiment, a basic function of the control system will be described. FIG. 1 is a block diagram illustrating a configuration example of a control system according to the first example embodiment. A control system 10 controls a screen displayed by a terminal device operable by a customer in a store.

The store may be, for example, a store such as a supermarket, a supermarket center, a convenience store, a mass merchandise store, a home center, a drug store, a store that handles apparel products, or an individual store such as a bakery or a daily dish store, and is not particularly limited.

When the identification information is read on a reading screen on which the identification information about the product can be read by the operation by the customer on the terminal device, a registration unit 103 registers the product indicated by the identification information in the list. Reading the identification information about the product means acquiring the identification information about the product. The list is a list of products to be purchased by a customer. Registering the product indicated by the identification information in the list means, for example, adding the identification information to the list.

The product identification information is not particularly limited as long as the product can be uniquely identified. The product identification information is, for example, a product code, a product name, an image of a product, or the like. Examples of the product code include a Japanese Article Number (JAN) code, a European Article Number (EAN) code, and a Universal Product Code (UPC), but are not particularly limited thereto. The product code may be displayed on the product by being represented by, for example, a one-dimensional code (barcode) and a two-dimensional code. The product code may be displayed on the product in a numeric string together with the one-dimensional code or the two-dimensional code.

A mode reception unit 101 receives either the sequential checking mode or the continuous mode. Receiving the mode by the mode reception unit 101 means receiving setting of the mode. Specifically, for example, the mode reception unit 101 may receive the mode by receiving information for identifying the mode. In the sequential checking mode, when the identification information is newly read on a reading screen capable of reading the identification information about the product by the operation by the customer on the terminal device, a list screen of a list after the newly read identification information is registered is displayed. Further, the sequential checking mode is a mode for displaying a reading screen when receiving a reading instruction on the list screen. The reading instruction is an instruction to newly read identification information about a product. The reading instruction is received, for example, by a customer's operation on the terminal device.

The continuous mode is a mode in which a reading screen is displayed when identification information is newly read on the reading screen. The term “continuous” as used herein means that reading can be performed once and new reading can be performed after product registration. In the following description, when reading of a one-dimensional code or the like is used, the continuous mode is also referred to as a continuous scan mode.

An example in which the mode reception unit 101 receives a mode will be described. For example, the mode reception unit 101 may receive a mode set as a default. Alternatively, for example, the mode reception unit 101 may receive the mode by a user operation for a terminal operation. The timing at which the mode reception unit 101 receives the mode may be a timing before the start of the product registration or a timing during the product registration, and is not particularly limited.

A display control unit 102 displays a screen that relates to the received mode on the terminal device. First, processing by the display control unit 102 in the sequential checking mode will be described. The display control unit 102 displays a reading screen on which the identification information about the product can be read by the operation by the customer on the terminal device. Then, when the identification information is newly read on the reading screen, the display control unit 102 displays a list screen of the list after the newly read identification information is registered. When receiving a reading instruction on the list screen, the display control unit 102 displays a reading screen. The display control unit 102 repeats the control of these displays until the product registration is completed.

Next, processing by the display control unit 102 in the continuous scan mode will be described. The display control unit 102 displays a reading screen on which the identification information about the product can be read by the operation by the customer on the terminal device. Then, when the identification information is newly read on the reading screen, the display control unit 102 keeps the reading screen displayed. The display control unit 102 repeats the display control until the product registration is completed.

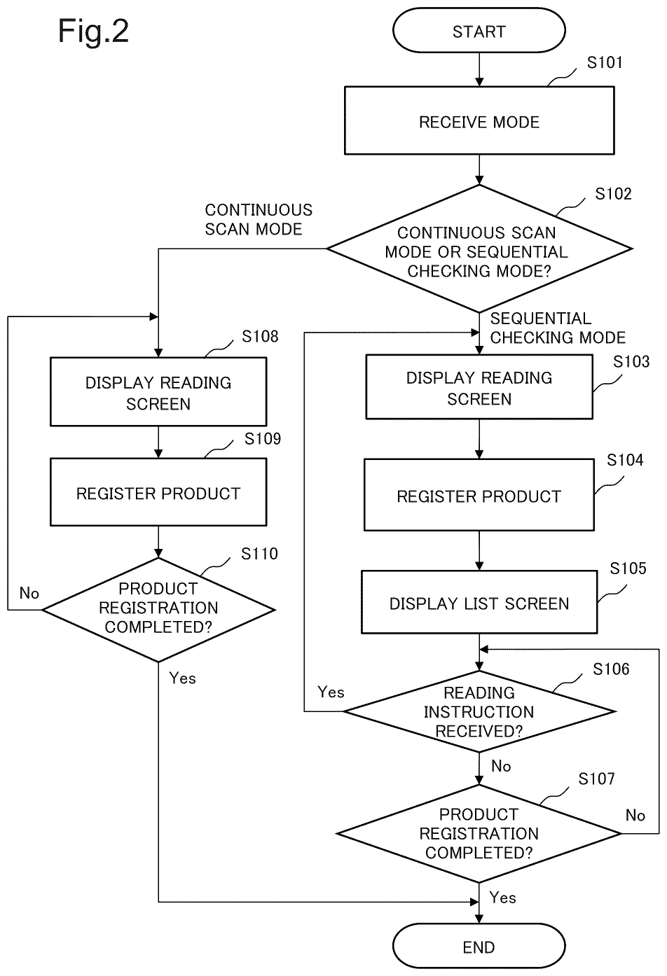

FIG. 2 is a flowchart illustrating an operation example of the control system 10 according to the first example embodiment. The timing at which the mode reception unit 101 receives the mode is not particularly limited, but an example in which the mode is first received before product registration will be described as an example for ease of description. The mode reception unit 101 receives a mode (step S101). The display control unit 102 determines whether the scan mode is the continuous scan mode or the sequential checking mode (step S102). In the case of the sequential checking mode (step S102: sequential checking mode), the display control unit 102 displays a reading screen on the terminal device (step S103).

When the identification information is newly read, the registration unit 103 registers the identification information in the list to perform product registration (step S104). Next, the display control unit 102 displays a list screen of the list after registration on the terminal device (step S105).

Next, the display control unit 102 determines whether a reading instruction has been received (step S106). When the reading instruction is received (step S106: Yes), the display control unit 102 returns the process to step S103. When the reading instruction has not been received (step S106: No), the display control unit 102 determines whether the product registration is completed (step S107). When the product registration is not completed (step S107: No), the display control unit 102 returns the process to step S106. As a result, the control system 10 waits until new reading or product registration is completed.

On the other hand, when the product registration is completed (step S107: Yes), the control system 10 ends the process.

In the case of the continuous scan mode (step S102: continuous scan mode), the display control unit 102 displays a reading screen on the terminal device (step S108). When the identification information is read, the registration unit 103 registers the identification information in the list to perform product registration (step S109).

Next, the display control unit 102 determines whether the product registration is completed (step S110). When the product registration is not completed (step S110: No), the display control unit 102 returns the process to step S108. In a case where the product registration is completed (step S110: Yes), the control system 10 ends the process.

After the product registration is completed, settlement or the like is performed. In step S107 and step S110, for example, whether the product registration has been completed is determined by whether a payment instruction or the like for making a payment has been received.

As described above, in the first example embodiment, the control system 10 can switch between the continuous scan mode in which the product registration can be continuously performed and the sequential checking mode in which the customer is caused to check the sequential list after the product registration. As a result, since each mode can be switched according to the customer's preference, convenience at the time of shopping can be improved.

The first example embodiment is not limited to the example described above, and various modifications can be made. Each function unit may be achieved by one device such as a control device. Specifically, for example, each function unit may be achieved by one server or one terminal device operable by a user. Alternatively, each function unit may be implemented by a plurality of devices. For example, each function unit may be achieved by a plurality of servers.

### Second Example Embodiment

Next, the second example embodiment will be described in detail with reference to the drawings. In the second example embodiment, a specific display example in each mode will be described with an example in which a barcode attached to a product is read. Hereinafter, description of content overlapping with the above description will be omitted to the extent that the description of the second example embodiment is not unclear.

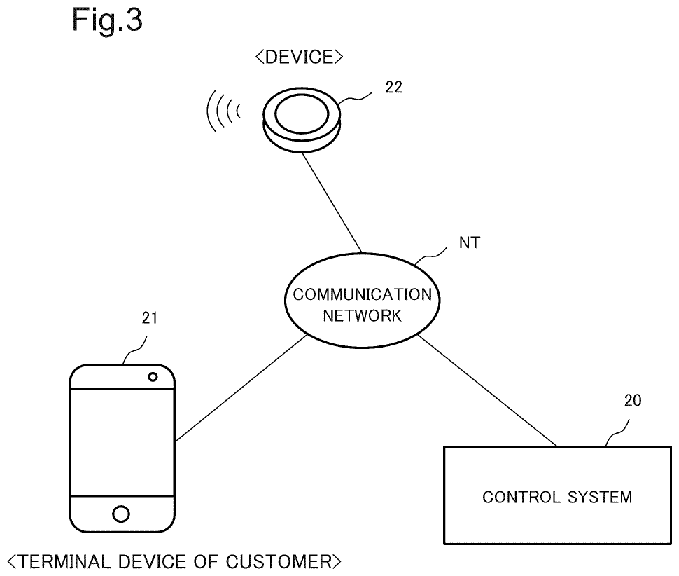

FIG. 3 is an explanatory diagram illustrating an example of connection between the control system and each device according to the second example embodiment. A control system 20 is connected to a terminal device 21 via a communication network NT. The control system 20 is connected to a beacon device 22 or the like via the communication network NT.

The terminal device 21 is a device operable by a customer. The terminal device 21 is an apparatus that can be carried by a customer. The terminal device 21 may be attached to a cart or the like. The terminal device 21 is not particularly limited, and examples of terminal device 21 include a smartphone, a tablet-type device, and a personal computer (PC). For example, in the terminal device 21, a specific application program may be installed in advance, and various types of information may be input and output via the specific application program.

For example, the terminal device 21 operable by the customer may capture an image of the one-dimensional code or the two-dimensional code by the imaging device of the terminal device 21, acquire the product code from the captured image to transmit the product code to the control system 20. Alternatively, for example, the terminal device 21 operable by the customer captures an image of the one-dimensional code or the two-dimensional code by the imaging device of the terminal device 21 to transmit the captured image to the control system 20. Then, the control system 20 may acquire the product code from the image. In the following description, an example in which the terminal device 21 acquires a product code from an image to transmit the acquired code to the control system 20 will be described. The number of terminal devices 21 is not particularly limited.

The device 22 is a device used to identify the position of the terminal device 21. The number of devices 22 is not particularly limited. The device 22 is fixedly disposed. More specifically, for example, the device 22 is disposed on a ceiling, a floor, a shelf, or the like of a store. For example, the plurality of devices 22 is dispersedly disposed at different positions in the store. For example, when the device 22 is a transmitter that transmits a radio wave, the terminal device 21 is a receiver that receives the radio wave. On the other hand, when the device 22 is a receiver that receives radio waves, the terminal device 21 is a transmitter that transmits radio waves. The device 22 is, for example, a beacon device. For example, the position of the terminal device 21 is estimated by the reception intensity of the radio wave transmitted and received between the device 22 and the terminal device 21.

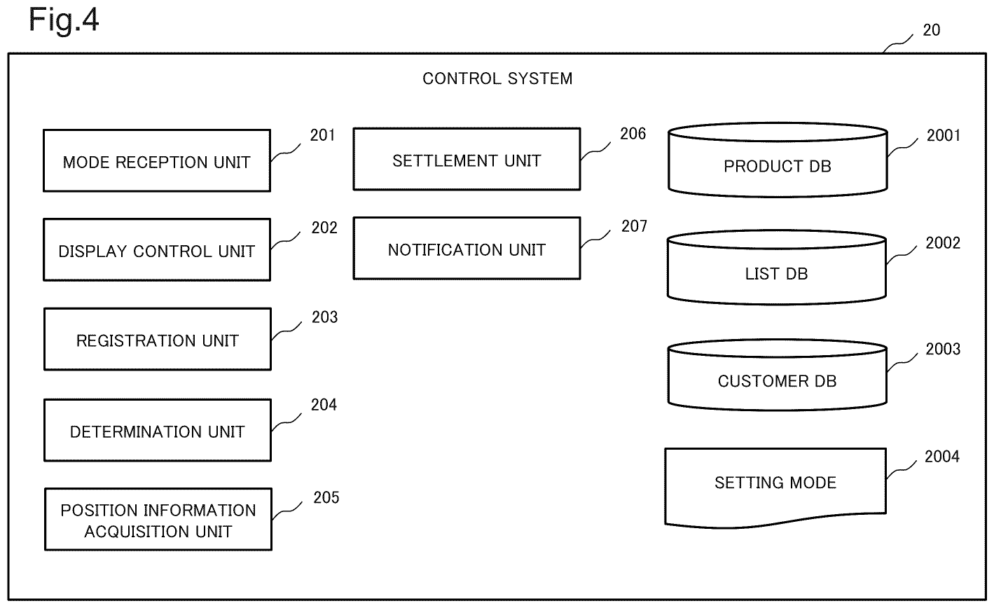

FIG. 4 is a block diagram illustrating a configuration example of the control system 20 according to the second example embodiment. The control system 20 includes a mode reception unit 201, a display control unit 202, a registration unit 203, a determination unit 204, a position information acquisition unit 205, a settlement unit 206, and a notification unit 207. The control system 20 according to the second example embodiment is different from control system 20 according to the first example embodiment in that the determination unit 204, the position information acquisition unit 205, the settlement unit 206, and the notification unit 207 are added. The mode reception unit 201, the display control unit 202, and the registration unit 203 according to the second example embodiment have basic functions of the mode reception unit 201, the display control unit 202, and the registration unit 203 according to the first example embodiment, respectively.

The control system 20 includes a product DB 2001, a list DB 2002, a customer DB 2003, and a setting mode 2004. The setting mode 2004 stores the received mode.

The product DB 2001 stores, for each product, identification information for identifying the product and product information in association with each other. For example, when the product identification information is a product code, the product information is information such as the name of the product and the price of the product. The product information is not particularly limited.

The list DB 2002 stores, for each customer, the latest list on which payment has not been completed. The list stores, for example, customer identification information for identifying a customer, identification information (for example, the product code) of a product to be purchased by the customer, and information about a purchase quantity in association with each other for each customer. The customer identification information is not particularly limited as long as it can uniquely identify a customer, for example. For example, before starting registration of a product to a new customer, a customer identifier (ID) is assigned to the customer as customer identification information. When the membership ID such as the point card number is received, the membership ID may be used as the customer ID. The list DB 2002 may store a list for each transaction. For example, in the case of each transaction, a transaction ID may be assigned instead of the customer ID. The list may be referred to as a shopping basket.

The customer DB 2003 stores customer information for each customer. For example, the customer DB 2003 stores customer identification information for identifying a customer and information about the customer in association with each other for each customer. For example, the information about the customer may be a purchase history of the customer, position information about the customer in the store, a movement history of the customer, a flag indicating whether it has been determined the operation is suspicious in the past as described later, or the like, and is not particularly limited.

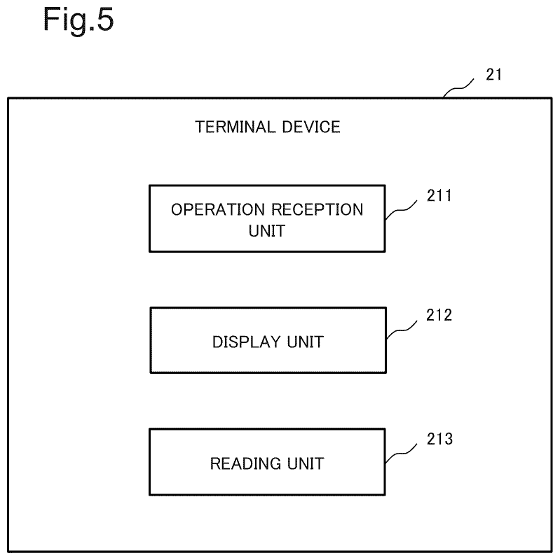

FIG. 5 is a block diagram illustrating a configuration example of the terminal device 21 according to the second example embodiment. The terminal device 21 stores an operation reception unit 211, a display unit 212, and a reading unit 213.

The operation reception unit 211 receives an operation on the input device by the customer. The type of the input device is not particularly limited, but an input/output device such as a touch panel display will be described as an example. The display unit 212 displays each screen on the display device of the terminal device 21 under the control of the display control unit 202. The reading unit 213 reads the identification information about the product. Hereinafter, an example in which the reading unit 213 captures an image of a barcode displayed on the imaging device of the terminal device 21 and obtains a product code from the captured image will be described.

Returning to the description of FIG. 4, the mode reception unit 201 receives either the sequential checking mode or the continuous scan mode. The mode reception unit 201 may receive the mode by the operation by the customer on the terminal device 21. Alternatively, the mode reception unit 201 may receive a predetermined default mode.

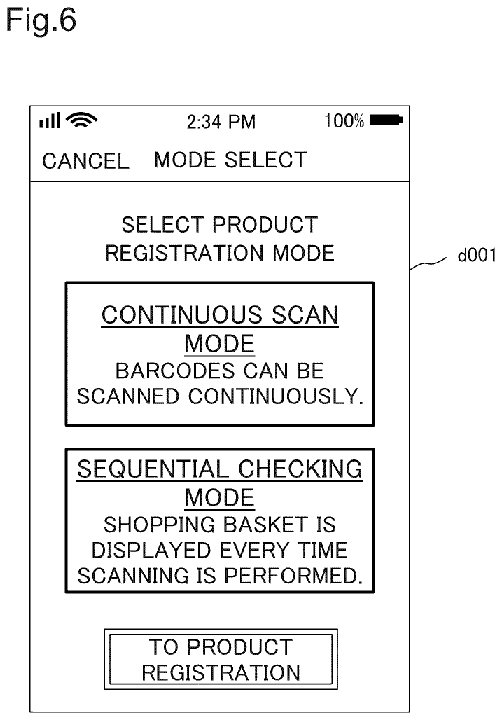

The timing at which the mode reception unit 201 receives the mode is not particularly limited. For example, this timing may be a timing of entering a store and starting shopping. That is, this timing is before starting product registration. This timing may be during display of the reading screen or the list screen in each mode. This timing may be a timing at which a new reading instruction is received. An example in which a mode is received at a timing of entering a store and starting shopping will be described with reference to FIG. 6. An example of receiving the mode while the reading screen is being displayed will be described later.

### <Example of Receiving Selection of Mode>

FIG. 6 is an explanatory diagram illustrating an example of receiving a mode. In FIG. 6, the display control unit 202 displays on the terminal device 21 a screen d001 on which either the sequential checking mode or the continuous scan mode can be selected. Then, the display unit 212 displays the screen d001 on the display device of the terminal device 21. The screen d001 includes a button capable of selecting the sequential checking mode and a button capable of selecting the continuous scan mode. The screen d001 includes a “TO PRODUCT REGISTRATION” button.

For example, when a button of one of the modes is selected and the “TO PRODUCT REGISTRATION” button is tapped, the operation reception unit 211 receives a mode related to the selected button. Then, the operation reception unit 211 transmits the received mode to the control system 20. The mode reception unit 201 receives the mode by receiving the mode. The mode reception unit 201 stores the received mode in the setting mode 2004. Then, for example, product registration may be started in each mode.

Next, the display control unit 202 displays a screen related to the mode on the terminal device 21.

### <Screen Example of Sequential Checking Mode>

First, the sequential checking mode will be described. The display control unit 202 displays a reading screen on which the product code can be read by the operation by the customer on the terminal device 21. Then, when the product code is newly read on the reading screen, the display control unit 202 displays a list screen of the list after the newly read product code is registered. When receiving a reading instruction on the list screen, the display control unit 202 displays a reading screen. The display control unit 202 repeats the control of the display until the product registration is completed. The reading screen may include information indicating the sequential checking mode.

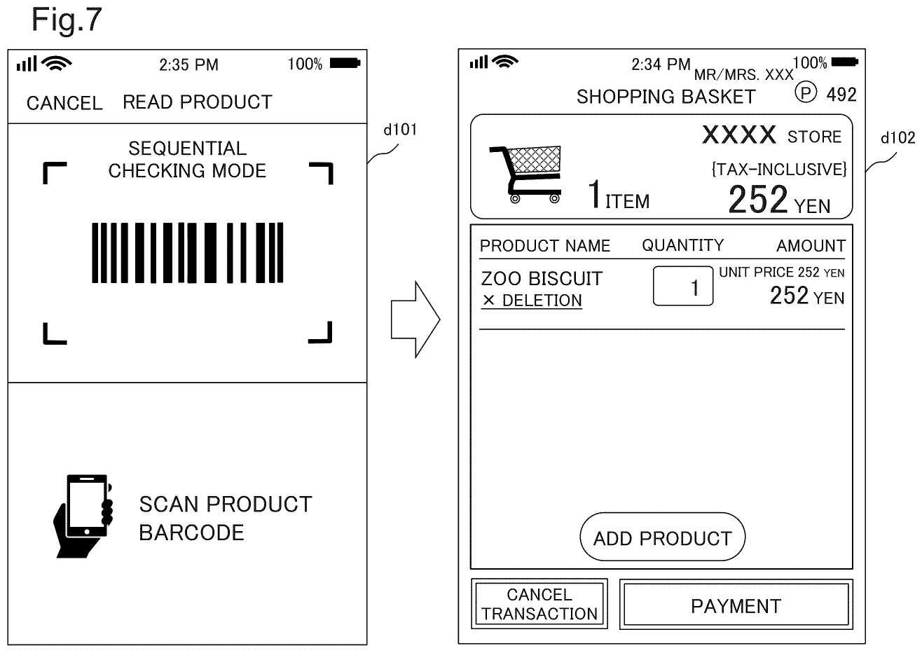

An example of screen transition of the terminal device 21 in the sequential checking mode will be described with reference to FIG. 7. FIG. 7 is an explanatory diagram illustrating a screen transition example of the terminal device 21 in the sequential checking mode. The display control unit 202 displays on the terminal device 21 a reading screen d101 on which a barcode can be read. Then, the display unit 212 displays a reading screen d101 on the display device of the terminal device 21.

The reading screen d101 includes information indicating the sequential checking mode, such as “sequential checking mode”. As a result, the customer can check which mode the customer is scanning.

In FIG. 7, an imaging device is activated in the terminal device 21. A reading frame is displayed on the reading screen d101. The reading frame indicates a position where the imaging device of the terminal device 21 can read the barcode. Hereinafter, the reading frame may be omitted and referred to as a frame. For example, when the barcode enters the frame of the reading screen d101, the reading unit 213 recognizes the barcode from the image. Then, the reading unit 213 transmits the product code represented by the barcode to the control system 20. The reading unit 213 may transmit the product code together with the customer ID or the transaction ID.

Upon receiving the product code, the registration unit 203 registers the product code in the list. As a specific example of the registration processing, the registration unit 203 searches for a list associated with the customer ID from the list DB 2002. Then, the registration unit 203 registers the product code in the searched list.

After the registration, the display control unit 202 displays a list screen d102 of products whose product codes are registered in the list. Then, the display unit 212 displays a list screen on the display device of the terminal device 21. In FIG. 7, a list of products is displayed on a list screen d102. The list screen d102 may include a button for changing the quantity of products, an “ADD PRODUCT” button, a “CANCEL TRANSACTION” button, and a “PAYMENT” button. The “CANCEL TRANSACTION” button is a button for ending the transaction. The “PAYMENT” button is a button for completing product registration and making a payment.

The “ADD PRODUCT” button is a button for receiving a reading instruction. For example, when the “ADD PRODUCT” button is tapped, the operation reception unit 211 determines that a reading instruction has been received to transmit the reading instruction to the control system 20. When receiving the reading instruction, the display control unit 202 displays the reading screen d101. Then, the display unit 212 displays a reading screen d101 on the display device of the terminal device 21.

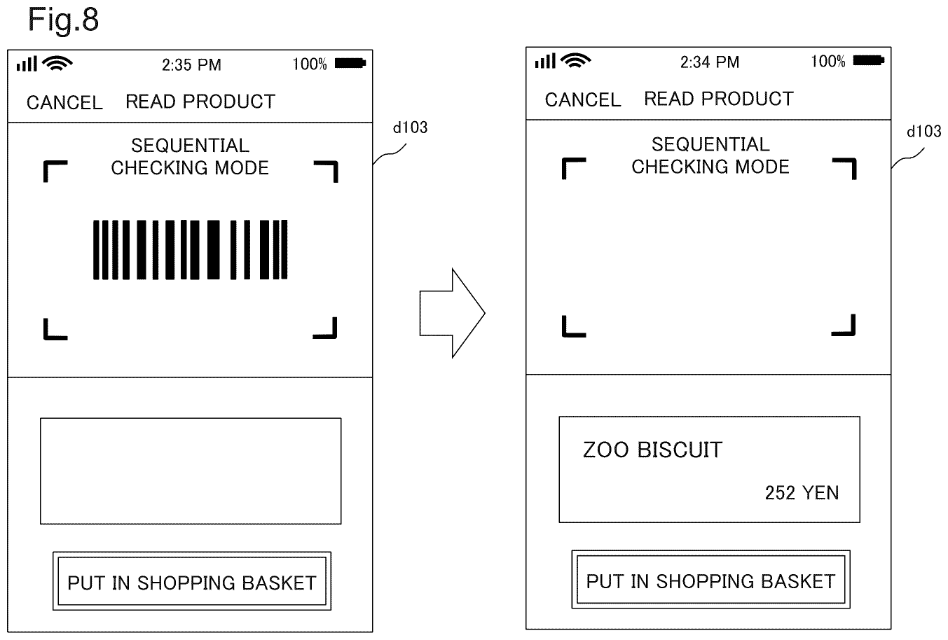

In the example of FIG. 7, when the product code is read on the reading screen d101, the product code is registered in the list by the registration unit 203, but the present invention is not limited thereto. After the product code is read on the reading screen and the registration instruction by the customer is received, the product code may be registered in the list by the registration unit 203. The registration instruction is an instruction to register the identification information that is the read product code in the list. A reading screen in this example will be described with reference to FIG. 8.

FIG. 8 is an explanatory diagram illustrating another example of the reading screen in the sequential checking mode. In FIG. 8, reading screen d103 includes a display field of information about a product related to the product code and a “PUT IN SHOPPING BASKET” button capable of receiving a registration instruction. For example, after the reading unit 213 transmits the read product code to the control system 20, the registration unit 203 identifies product information related to the product code from the product DB 2001. Then, the display control unit 202 displays the product information on the reading screen d103. In order to display the product information, the display control unit 202 may transmit the product information to the terminal device 21. The display unit 212 may display the product information in the display field on the reading screen d103. In FIG. 8, the product name and the price of the product are displayed.

Then, when the “PUT IN SHOPPING BASKET” button is tapped, the operation reception unit 211 determines that the registration instruction is received to transmit the registration instruction to the control system 20. When receiving the registration instruction, the registration unit 203 registers the product code in the list. Then, after the registration, the display control unit 202 displays a list screen d102 as illustrated in FIG. 7.

In this manner, the product code may be registered from the reading of the product code by two-stage operation of the reading operation of reading the product code and the registration operation of registering the product code after reading.

For example, in a case where a new product code is read without receiving a registration instruction, the previous product code may not be registered in the list.

### <Screen Example of Continuous Scan Mode>

Next, the continuous scan mode will be described. The display control unit 202 displays a reading screen on which the product code can be read by the operation by the customer on the terminal device 21. Then, when the product code is newly read on the reading screen, the display control unit 202 keeps the reading screen displayed. The display control unit 202 repeats the display control until the product registration is completed. However, in the continuous scan mode, the display control unit 202 may display a list screen when receiving a list display instruction on the reading screen, and may display a reading screen when receiving a reading instruction on the list screen. The display instruction is an instruction to cause the terminal device 21 to display the list. That is, the display instruction is an instruction to display the list screen on the terminal device 21. The reading screen may include information indicating the continuous scan mode.

When the product code is read in the continuous scan mode, the display control unit 202 may display information about the product identified by the read product code on the reading screen. The product information is, for example, a product name, a product price, and the like included in the product DB 2001.

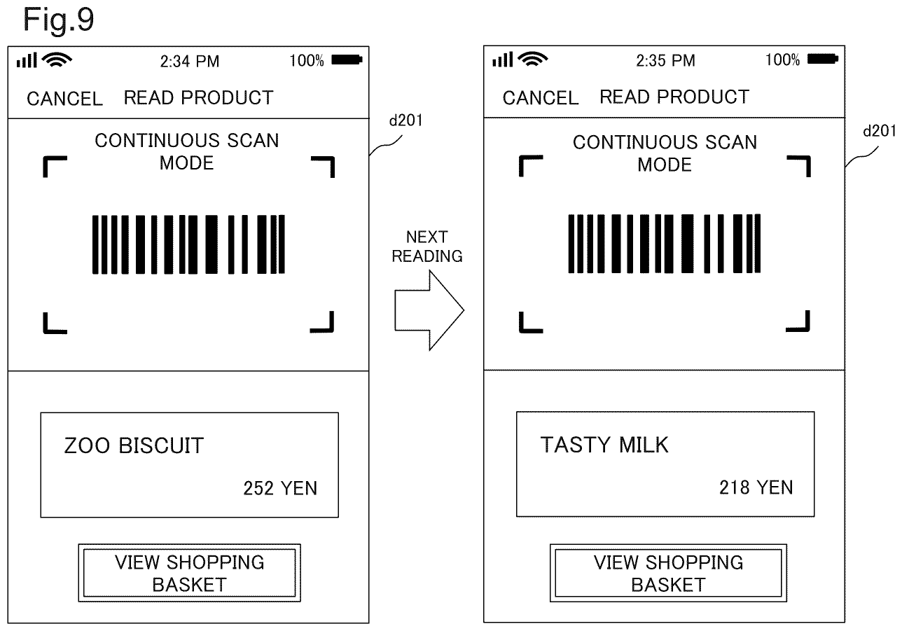

FIG. 9 is an explanatory diagram illustrating an example of screen transition in the continuous scan mode. In FIG. 9, for example, in the continuous scan mode, the display control unit 202 displays a reading screen d201 on the terminal device 21. Then, the display unit 212 displays the reading screen d201 on the display device of the terminal device 21.

The reading screen d201 includes information indicating the sequential checking mode, such as “CONTINUOUS SCAN MODE”. As a result, the customer can check which mode the customer is scanning.

In FIG. 9, an imaging device is activated in the terminal device 21. A reading frame is displayed on the reading screen d201. In FIG. 9, reading screen d201 includes a display field of information about registered products and a “VIEW SHOPPING BASKET” button that can receive a display instruction of a list.

For example, when the barcode enters the frame of the reading screen d201, the reading unit 213 recognizes the barcode from the image. Then, the reading unit 213 transmits the product code represented by the barcode to the control system 20. The reading unit 213 may transmit the product code together with the customer ID or the transaction ID.

Upon receiving the product code, the registration unit 203 registers the product code in the list. As a specific example of the registration processing, the registration unit 203 searches for a list associated with the customer ID from the list DB 2002. Then, the registration unit 203 registers the product code in the searched list.

Next, the registration unit 203 identifies the information about the product associated with the product code from the product DB 2001. Then, the display control unit 202 displays the product information in the display field of the product information on the reading screen d201. The display unit 212 displays information about the registered product on the reading screen d201. In FIG. 9, on the reading screen d201, “ZOO BISCUIT” as the name of the registered product and “252 YEN” as the price are displayed in the display field.

When the information about the registered product is displayed, the product code can be read on the reading screen d201. Accordingly, the next reading is performed. For example, the reading unit 213 reads a new product code on the reading screen d201 to transmit the new product code to the control system 20. The registration unit 203 identifies the information about the product associated with the product code from the product DB 2001. Then, the display control unit 202 displays the product information in the display field of the product information on the reading screen d201. The display unit 212 displays information about the registered product on the reading screen d201. In FIG. 9, on the reading screen d201, “TASTY MILK” as the name of the registered product and “218 YEN” as the price are displayed in the display field.

In this manner, the products can be sequentially registered while the reading screen d201 is displayed. Therefore, when a customer with a large number of products, a customer who is accustomed to the operation, or the like uses the continuous scan mode, it is possible to shorten the time required for product registration, and it is possible to improve customer convenience.

When the “VIEW SHOPPING BASKET” button is tapped, the operation reception unit 211 determines that a list display instruction has been received to transmit the list display instruction to the control system 20. Then, when receiving the list display instruction, the display control unit 202 displays a list screen on the terminal device 21.

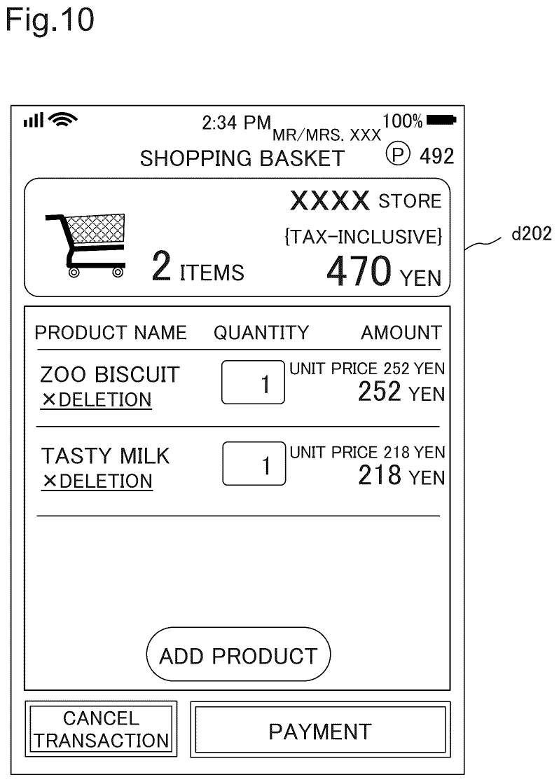

FIG. 10 is an explanatory diagram illustrating an example of a list screen in the continuous scan mode. The display control unit 202 displays a list screen d202 of products whose product codes are registered in the latest list. Then, the display unit 212 displays the list screen d202 on the display device of the terminal device 21. In FIG. 10, a list of products is displayed on a list screen d202. The list screen d202 may include a button for changing the quantity of products, an “ADD PRODUCT” button, a “CANCEL TRANSACTION” button, and a “PAYMENT” button. The “CANCEL TRANSACTION” button is a button for ending the transaction. The “PAYMENT” button is a button for completing product registration and making a payment. In FIG. 10, information about two products registered as products in FIG. 9 is displayed on the list screen d202.

The “ADD PRODUCT” button is a button for receiving a reading instruction. For example, when the “ADD PRODUCT” button is tapped, the operation reception unit 211 determines that a reading instruction has been received to transmit the reading instruction to the control system 20. When receiving the reading instruction, the display control unit 202 causes the terminal device 21 to display the reading screen d201. Then, the display unit 212 displays the reading screen d201 on the display device of the terminal device 21.

The list screen may be the same in the continuous scan mode and the sequential checking mode.

Although not illustrated, the screen d001 for selecting a mode as illustrated in FIG. 6 may be displayed after receiving a reading instruction on the list screen in any mode as described above. Alternatively, the display control unit 202 may display, on the terminal device 21, the screen d001 for selecting a mode as illustrated in FIG. 6 every time a reading instruction is received a predetermined number of times on the list screen or every time a predetermined time elapses from the start of product registration.

The reading screen d201 illustrated in FIG. 9 is an example, and is not particularly limited.

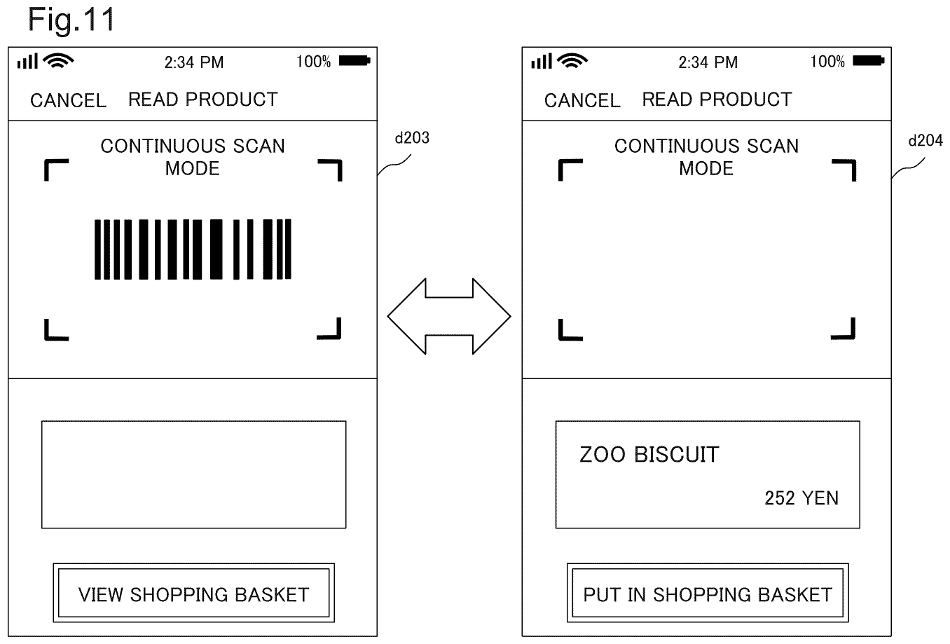

FIG. 11 is an explanatory diagram illustrating another example of the reading screen in the continuous scan mode. In FIG. 11, for example, in the continuous scan mode, the display control unit 202 displays a reading screen d203 capable of receiving a list display instruction on the terminal device 21. Then, the display unit 212 displays the reading screen d203 on the display device of the terminal device 21.

In FIG. 11, reading screen d203 includes a display field of information about registered products and a “VIEW SHOPPING BASKET” button that can receive a display instruction of a list.

For example, when reading the product code, the reading unit 213 transmits the product code to the control system 20. When receiving the product code, the registration unit 203 acquires the information about the product associated with the product code from the product DB 2001. Then, the display control unit 202 displays a reading screen d204 capable of receiving a registration instruction. At this time, the display control unit 202 displays the product information in the display field of the product information on the reading screen d204. The display unit 212 displays product information on the reading screen d204. In FIG. 11, the product name and the price of the product are displayed. In FIG. 11, on the reading screen d204, “ZOO BISCUIT” as the name of the product and “252 YEN” as the price are displayed in the display field.

Reading screen d204 on which the product information is being displayed includes a “PUT IN SHOPPING BASKET” button that can receive a registration instruction. Then, when the “PUT IN SHOPPING BASKET” button is tapped, the operation reception unit 211 determines that the registration instruction is received to transmit the registration instruction to the control system 20. When receiving the registration instruction, the registration unit 203 registers the product code in the list. Then, after the registration, the display control unit 202 displays the reading screen d203 capable of receiving a list display instruction. The display unit 212 displays the reading screen d203. Thus,

In this manner, the product code may be registered from the reading of the product code by two-stage operation of the reading operation of reading the product code and the registration operation of registering the product code after reading.

(Example of Receiving Mode while Reading Screen is Displayed)

Next, an example in which the mode reception unit 201 receives another mode while displaying the reading screen in each mode will be described.

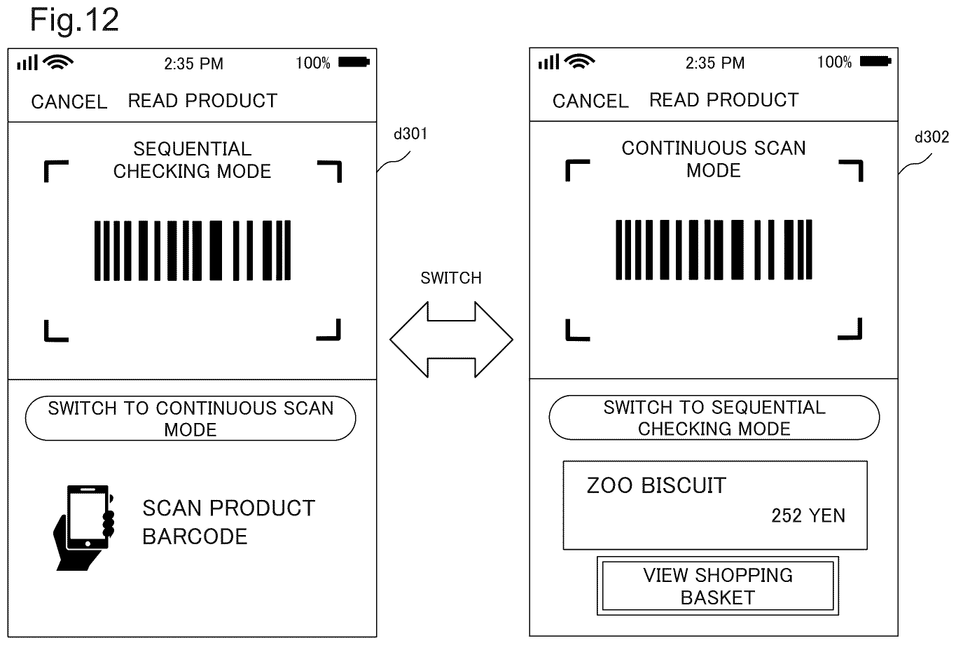

For example, the mode reception unit 201 may receive the continuous scan mode on the reading screen of the sequential checking mode. For example, the mode reception unit 201 may receive the continuous scan mode on the reading screen of the continuous scan mode. The mode reception unit 201 stores the received mode in the setting mode 2004. A specific reception example will be described with reference to FIG. 12.

FIG. 12 is an explanatory diagram illustrating an example of receiving a mode during display of a reading screen. First, the sequential checking mode will be described. For example, a reading screen d301 in the sequential checking mode may further include a button capable of receiving the continuous scan mode. In FIG. 12, this button is a “SWITCH TO CONTINUOUS SCAN MODE” button. When the “SWITCH TO CONTINUOUS SCAN MODE” button is tapped, the operation reception unit 211 determines that the continuous scan mode has been received to transmit the continuous scan mode to the control system 20. Transmitting the mode means, for example, transmitting information for identifying the mode. The mode reception unit 201 receives the continuous scan mode by receiving the continuous scan mode. When receiving the continuous scan mode, the display control unit 202 displays a reading screen d302 in the continuous scan mode.

Next, the continuous scan mode will be described. For example, the reading screen d302 in the continuous scan mode may further include a button capable of receiving the sequential checking mode. In FIG. 12, this button is a “SWITCH TO SEQUENTIAL CHECKING MODE” button. When the “SWITCH TO SEQUENTIAL CHECKING MODE” button is tapped, the operation reception unit 211 determines that the sequential mode has been received to transmit the sequential checking mode to the control system 20. The mode reception unit 201 receives the sequential checking mode by receiving the sequential checking mode. Then, when receiving the sequential checking mode, the display control unit 202 displays the reading screen d301 in the sequential checking mode. The present invention is not limited to the example in which the reading screen d301 is displayed after the sequential checking mode is received, and the display control unit 202 may display a list screen in the sequential checking mode when the sequential checking mode is received.

As described above, as in the reading screen d301 and the reading screen d302, each mode can be switched by each reading screen.

The example of receiving the mode during the display of the reading screen in each mode is not limited thereto. For example, the display control unit 202 may superimpose and display a screen capable of receiving the mode on the reading screen.

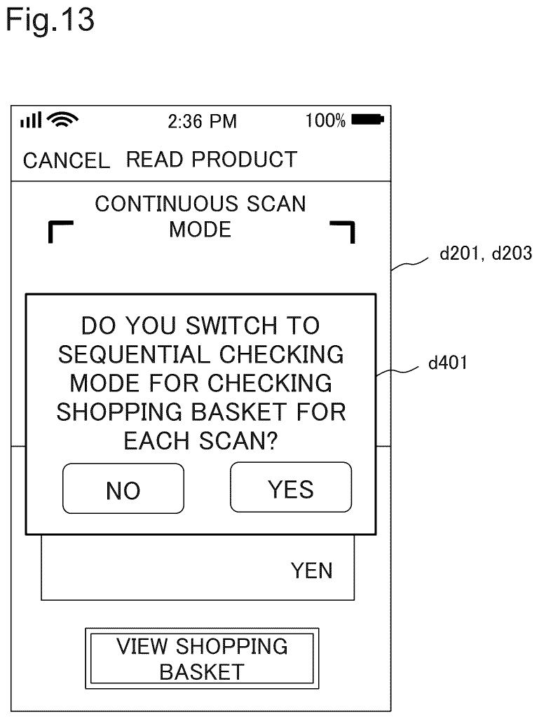

FIG. 13 is an explanatory diagram illustrating an example in which a screen for receiving a mode is superimposed and displayed on a reading screen. The continuous scan mode is taken as an example. In the continuous scan mode, the display control unit 202 superimposes and displays a screen d401 for receiving the mode on the reading screen d201, d203 at a predetermined timing. The predetermined timing may be when it is determined that the operation by the customer is suspicious as described later, or is not particularly limited as in a case where the operation is not performed for a predetermined time.

Then, in the continuous scan mode, the display unit 212 superimposes and displays a screen d401 capable of receiving the sequential checking mode on the reading screen d201, d203. In FIG. 13, the screen d401 capable of receiving the sequential checking mode includes a “YES” button and a “NO” button. When “YES” is tapped, the operation reception unit 211 determines that the sequential checking mode has been received to transmit the sequential checking mode. Then, the mode reception unit 201 receives the sequential checking mode by receiving the sequential checking mode.

Although not illustrated, the display control unit 202 may superimpose and display a screen capable of receiving the continuous scan mode on the reading screen d101, d103 in the sequential checking mode at a predetermined timing. The predetermined timing may be, for example, when the number of registered products per unit time is equal to or more than a predetermined number, or is not particularly limited.

As described above, an example of receiving the mode while the reading screen is being displayed in each mode is not particularly limited. For example, the mode reception unit 201 may switch to the sequential checking mode in a case where a new product code is not read for a predetermined time or more in the continuous scan mode.

The display control unit 202 may display a list screen of the list in a case where a new product code is not read for a predetermined time or more in the continuous scan mode. Then, the display unit 212 displays the list screen of the list. At this time, as described above, the mode reception unit 201 may switch from the continuous scan mode to the sequential checking mode in a case where a new product code is not read for a predetermined time or more. Alternatively, the display control unit 202 may display the list screen in the continuous scan mode.

In a case where a new product code is not read for a predetermined time or more in the sequential checking mode, the display control unit 202 may display the list screen of the list in the sequential checking mode. Then, the display unit 212 displays the list screen of the list.

### (Determination Example of Suspicious Action by Customer)

Next, in the continuous scan mode, since the customer can register the products one after another, the customer performs an action as if performing product registration, but it is conceivable that actually, the customer shoplifts without performing product registration. Therefore, the control system 20 determines whether an action of pretending that the product registration has been performed has been performed.

Determination unit 204 determines whether the action by the customer is suspicious. The determination method is not particularly limited, but examples of four determination methods will be described.

### <Determination Example 1>

The number of digits of the product code is determined in advance, such as 13 digits or 7 digits. For example, when the code with less than these digits is read many times, it is conceivable that the customer pretends to have registered the product. Therefore, the determination unit 204 determines whether the action by the customer is suspicious based on whether the newly read product code has a predetermined number of digits. More specifically, for example, in a case where it is continuously determined a predetermined number of times that the newly read product code is not the predetermined number of digits or is less than the predetermined number of digits, the determination unit 204 determines that the action by the customer is suspicious. The predetermined number of times is not particularly limited, and may be determined by a store clerk. Alternatively, for example, in a case where it is continuously determined for a predetermined time or more that the newly read product code does not have the predetermined number of digits or is less than the predetermined number of digits, the determination unit 204 determines that the action by the customer is suspicious. The predetermined time is not particularly limited, and may be determined by a store clerk.

### <Determination Example 2>

In a case where an action of pretending that the product registration has been performed is performed, it is conceivable to quickly hold the barcode of each product over the imaging device of the terminal device 21. For this reason, when the barcode of each product is swiftly held many times, the product code may be read accidentally. In such a case, it is estimated that the time required for reading is short.

Therefore, the determination unit 204 determines whether the action by the customer is suspicious based on whether the time required to newly read the product code is within a predetermined time. For example, in a case where the time required to newly read the product code is within a predetermined time, the determination unit 204 determines that the action by the customer is suspicious.

### <Determination Example 3>

For example, in a case where an action of pretending that the product registration has been performed is performed, there is a case where each product is passed in such a way that the barcode does not appear in the imaging device of the terminal device 21. In such a case, it is conceivable that the product code is not read on the reading screen for a long time. Therefore, the determination unit 204 determines whether the action by the customer is suspicious based on whether the new product code has not been read for a predetermined time or more. For example, in a case where the new product code has not been read for a predetermined time or more, the determination unit 204 determines that the action by the customer is suspicious.

### <Determination Example 4>

For example, in a case where an action of pretending that the product registration has been performed is performed, there is a case where each product is passed in such a way that the barcode does not appear in the imaging device of the terminal device 21. In such a case, an object may appear in the imaging device of the terminal device 21. Therefore, the determination unit 204 determines whether the action by the customer is suspicious based on whether passage of the object is confirmed within the angle of view of the imaging device of the terminal device 21 equal to or more than a predetermined number of times within a predetermined time. Specifically, for example, in a case where passage of an object is confirmed by the imaging device of the terminal device 21, the determination unit 204 determines that the action by the customer is suspicious.

This is the end of the description of each determination method.

### <Response to Suspicious Case>

Next, when it is determined that the action by the customer is suspicious, the control system 20 may switch from the continuous scan mode to the sequential checking mode, or may notify the store clerk of the suspicious action.

For example, the mode reception unit 201 may receive the sequential checking mode when it is determined that the action by the customer is suspicious in the continuous scan mode. As a result, when a suspicious action is detected, it is possible to forcibly switch to the sequential checking mode.

When it is determined that the action by the customer is suspicious in the continuous scan mode, the display control unit 202 may superimpose and display a screen for receiving the mode on the reading screen as illustrated in FIG. 13.

When it is determined that the action by the customer is suspicious in the continuous scan mode, the display control unit 202 may display a caution to the customer, an inquiry to the customer, or the like on the reading screen. For example, the caution or inquiry to the customer may be a comment suggesting that reading by the customer is not successful. For example, the caution or inquiry to the customer may be an inquiry about necessity of calling a store clerk because the reading of the customer is not successful.

When it is determined that the action by the customer is suspicious, the notification unit 207 may notify the store clerk that the action by the customer is suspicious. The notification method by the notification unit 207 is not particularly limited, and examples of the notification method by the notification unit 207 include an electronic message, an electronic mail, display control of a terminal device of a store clerk, and output control of an output device such as a lighting device or a display device installed in a store. The terminal device of the store clerk is not illustrated. For example, the notification unit 207 makes a notification to the terminal device of the store clerk.

The notification unit 207 may notify the store clerk of the suspicious action together with customer identification information for identifying a customer such as a customer ID.

The notification unit 207 may make a notification of the position information about the customer together at the time of notification. Specifically, for example, the position information acquisition unit 205 acquires the position information about the customer. A method of acquiring the position information about the customer is not particularly limited. As a method of acquiring the position information, the position information identification unit may acquire the position information about the customer by identifying the position of the customer by an imaging device installed in the store. Alternatively, as another acquisition method, the position information identification unit may acquire the position information about the customer by identifying the position of the terminal device 21 by wireless communication between the device 22 and the terminal device 21 of the customer.

For example, the terminal device of the store clerk may display that the position of the customer and the action by the customer are suspicious on the map of the store. The display control unit 202 may control the display on the terminal device of the store clerk.

For example, in a case where there is a plurality of store clerks, the notification unit 207 makes a notification to some or all of the plurality of store clerks. For example, the notification unit 207 may make a notification to a store clerk whose distance from the position of the customer is within a predetermined distance. Alternatively, for example, in a case where there is a plurality of store clerks, the notification unit 207 may make a notification to the store clerk closest to the position of the customer. The position information about the store clerk may be position information about the terminal device of the store clerk, or may be position information identified from an image or a video captured by an imaging device installed in the store. As a method of identifying the position information about the terminal device of the store clerk, a beacon or the like may be used as in the position information about the terminal device of the customer.

For example, the notification unit 207 may control lighting of a lighting device installed in the vicinity of the position indicated by the position information about the customer. For example, lighting on or off indicating that the action by the customer is suspicious may be determined in advance, and for example, the notification unit 207 may control the lighting device to be turned on or off in a determined manner. Lighting means blinking at predetermined intervals, constant lighting, lighting in a predetermined color, and the like. As a result, the store clerk can grasp that a customer performing a suspicious action is nearby by looking at the lighting device.

For example, in a case where it is determined that the action is suspicious, the determination unit 204 may set a flag indicating whether the action has been determined to be suspicious in the past in the customer DB 2003 to a value indicating that the customer has been determined to be suspicious. For example, the customer DB 2003 is not limited to the flag indicating whether the action has been determined to be suspicious in the past, and may store the number of times the customer has been determined to be suspicious in the past. In this case, when the customer has been determined to be suspicious, the determination unit 204 may count up the number of times the customer has been determined to be suspicious in the past in the customer DB 2003.

### (Settlement)

For example, the settlement may be performed in the terminal device 21 or may be performed in another payment device, and the settlement method is not particularly limited.

An example performed in the terminal device 21 will be described. For example, when the “PAYMENT” button on the list screen is tapped in each mode, the operation reception unit 211 determines that the product registration is completed to transmit a payment instruction to the control system 20. Then, when receiving the payment instruction, the settlement unit 206 generates payment information including the tax-included total value of the prices of the products indicated by the product codes included in the list. Then, the display control unit 202 displays the payment information on the terminal device 21. The display unit 212 displays the payment information.

Upon receiving the settlement instruction, the operation reception unit 211 transmits the settlement instruction to the control system 20. When receiving the settlement instruction, the settlement unit 206 makes a settlement. For example, a settlement method performed using the terminal device 21 is not particularly limited, and examples of the settlement method performed using the terminal device 21 include a credit settlement, a code settlement, and an electronic money settlement.

### <Operation Example of Control System 20>

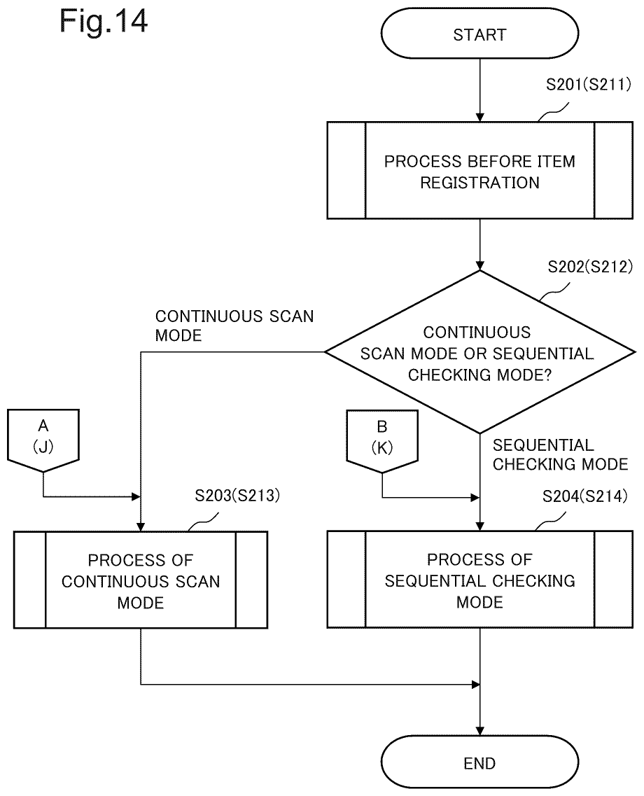

FIG. 14 is a flowchart illustrating an operation example of the control system 20 according to the second example embodiment. The control system 20 performs a process before product registration (step S201). Then, the control system 20 determines whether the mode is the continuous scan mode or the sequential checking mode (step S202).

In the case of the continuous scan mode (step S202: continuous scan mode), the control system 20 performs a process of the continuous scan mode (step S203). On the other hand, in the sequential checking mode (step S202: sequential checking mode), the control system 20 performs a process of the sequential checking mode (step S204). When the process in each mode ends, the control system 20 ends the process.

As in the control system 20, the terminal device 21 operates in the order illustrated in FIG. 14. Therefore, although a description of the entire operation example by the terminal device 21 is omitted, an operation example of each process will be described. Step S211, step S212, step S213, step S214, symbol J, and symbol K in ( ) are steps and symbols by the terminal device 21, and are used in the description of each process by the terminal device 21 described later. However, the terminal device 21 may not perform the process of determining which mode the current mode is (step S212). The reason is that the terminal device 21 is only required to display each screen and receive each operation by the customer according to the control by the display control unit 202.

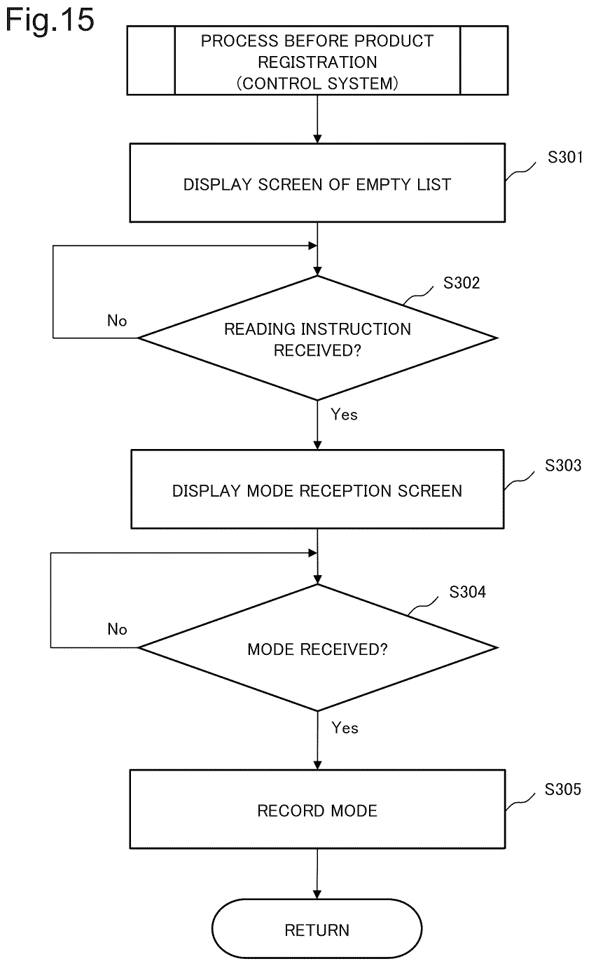

FIG. 15 is a flowchart illustrating an example of a specific processing procedure of the process (step S201) before product registration by the control system 20. The timing of receiving the mode is not particularly limited, but in order to facilitate the description, as an example, FIG. 15 illustrates an example of receiving the selection of the mode by the operation by the customer before starting the product registration. For example, the display control unit 202 displays a list screen of an empty list on the terminal device 21 (step S301). Since the scan has not been started, the list is empty. The display control unit 202 determines whether a reading instruction has been received (step S302). When the reading instruction has not been received (step S302: No), the display control unit 202 returns the process to step S302.

When the reading instruction has been received (step S302: Yes), the display control unit 202 displays a mode reception screen (step S303). An example of this screen is the screen d001 illustrated in FIG. 6.

The mode reception unit 201 determines whether the mode has been received (step S304). The mode reception unit 201 receives the mode by receiving the mode. When the mode has not been received (step S304: No), the mode reception unit 201 returns the process to step S304. When the mode is received (step S304: Yes), the mode reception unit 201 records the received mode in the setting mode 2004 (step S305). After step S305, the control system 20 returns the process. As a result, the control system 20 performs a process according to the selected mode.

The present invention is not limited to the example of receiving the mode by the operation by the customer before the product registration, and the mode reception unit 201 may receive a preset default mode or a mode set in the past by the customer. For example, the mode reception unit 201 may receive the mode by the operation by the customer as the initial setting of the specific application program, and is not particularly limited.

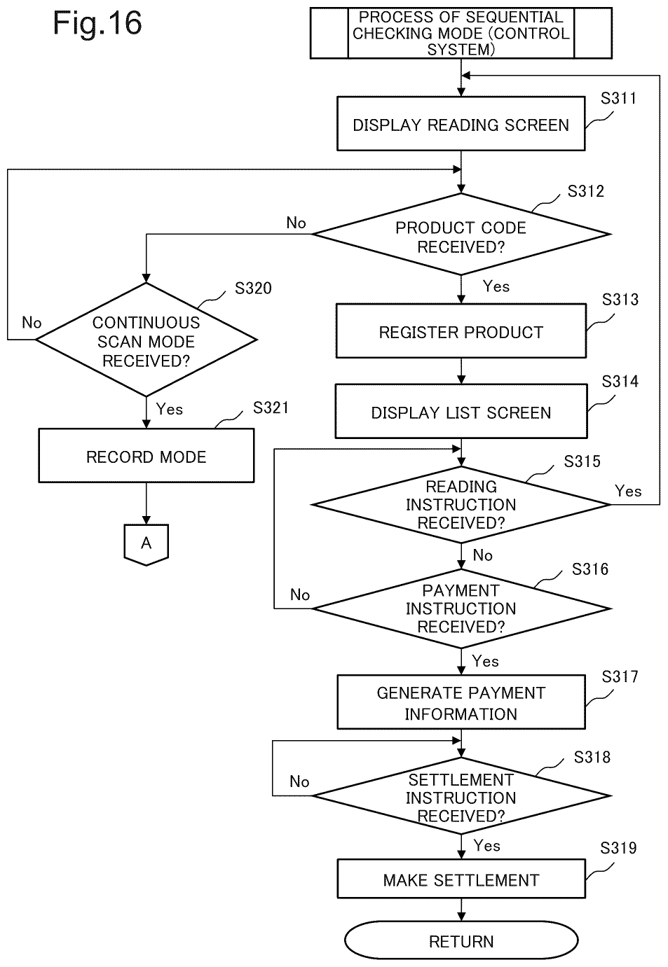

FIG. 16 is a flowchart illustrating an example of a specific processing procedure of the process of the sequential checking mode (step S204) by the control system 20. In the example illustrated in FIG. 16, an example in which the control system 20 receives the product code read by the terminal device 21 and registers the product will be described. The display control unit 202 displays a reading screen on the terminal device 21 (step S311). Examples of the reading screen here include the reading screen d101 illustrated in FIG. 7 and the reading screen d302 illustrated in FIG. 12.

Next, the registration unit 203 determines whether the product code has been received (step S312). When the reception code has not been received (step S312: No), the mode reception unit 201 determines whether the continuous scan mode has been received (step S320). The determination in step S320 is performed in a case where a button capable of switching the mode is displayed on the reading screen as in the reading screen d302 illustrated in FIG. 12. When the continuous scan mode has not been received (step S320: No), the registration unit 203 returns the process to step S312.

On the other hand, when the continuous scan mode is received (step S320: Yes), the mode reception unit 201 records the received mode in the setting mode 2004 (step S321), and advances the process to step S203. As a result, the mode is switched from the sequential checking mode to the continuous scan mode, and the process of the continuous scan mode (step S203) is performed.

When the product code is received (step S312: Yes), the registration unit 203 performs product registration (step S313). The display control unit 202 displays the list screen of the list after registration (step S314). The display control unit 202 determines whether a reading instruction has been received (step S315). When the reading instruction has been received (step S315: Yes), the display control unit 202 returns the process to step S311. As a result, a new reading screen is displayed on the terminal device 21.

When a reading instruction has not been received (step S315: No), the display control unit 202 determines whether a payment instruction has been received (step S316). The payment instruction is transmitted from the terminal device 21, for example, in a case where a “PAYMENT” button or the like is tapped on the terminal device 21. When the payment instruction has not been received (step S316: No), the display control unit 202 returns the process to step S315. As a result, the control system 20 waits for a reading instruction or a payment instruction.

On the other hand, in a case where the payment instruction has been received (step S316: Yes), the settlement unit 206 generates payment information (step S317). The display control unit 202 displays the payment information on the terminal device 21.

Then, the settlement unit 206 determines whether the settlement instruction has been received (step S318). For example, in the case of a credit card payment, the settlement instruction is transmitted from the terminal device 21 when information necessary for a credit settlement is input in the terminal device 21 and a button such as payment confirmed is tapped. Then, in a case where the settlement instruction has not been received (step S318: No), the settlement unit 206 returns the process to step S318. On the other hand, when the settlement instruction is received (step S318: Yes), the settlement unit 206 makes the settlement (step S319). After step S319, the control system 20 returns the process. As a result, the control system 20 ends the series of processing.

Steps S317 to S319 are an example of a case where the settlement is made via the terminal device 21. For example, the settlement may be made via a payment device or the like.

The order of each step can be changed as appropriate. For example, the order of step S312 and step S320 is not particularly limited. The order of step S315 and step S316 is not particularly limited. By storing the mode in the setting mode 2004, when a new transaction is started, the stored mode may be used without newly receiving the mode by the operation by the customer.

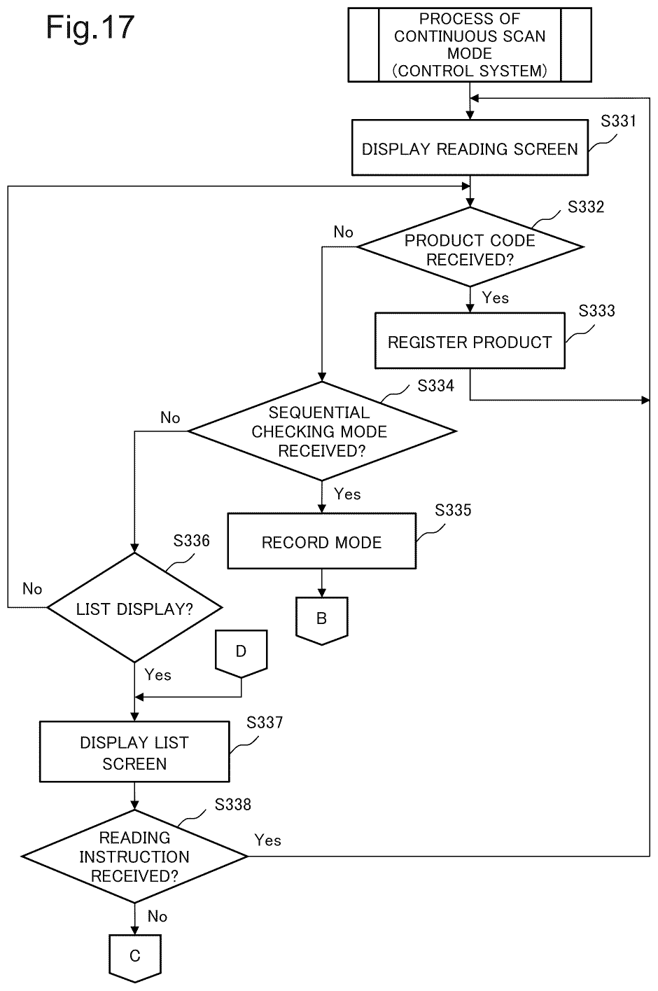

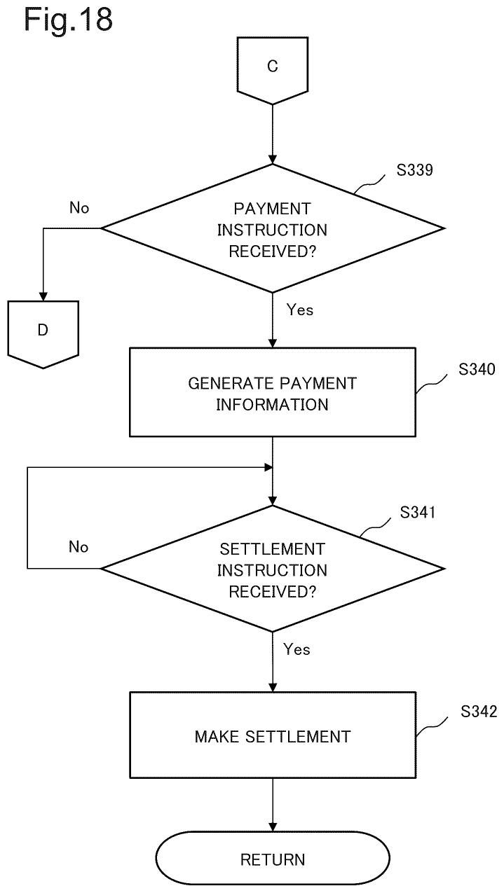

FIGS. 17 and 18 are flowcharts illustrating an example of a specific processing procedure of the process of the continuous scan mode (step S203) by the control system 20. First, the display control unit 202 displays a reading screen (step S331). The registration unit 203 determines whether the product code has been received (step S332). When the product code is received (step S332: Yes), the registration unit 203 performs product registration (step S333), and returns the process to step S331. As a result, the reading screen remains displayed. In step S331, after the product registration, the display control unit 202 may display product information such as a price and a product name of the registered product in the display field of the reading screen.

On the other hand, when the product code has not been received (step S332: No), the mode reception unit 201 determines whether the sequential checking mode has been received (step S334). The determination in step S334 is performed in a case where a button capable of switching the mode is displayed on the reading screen as in the screen illustrated in FIG. 12.

When the sequential checking mode is received (step S334: Yes), the mode reception unit 201 records the received mode in the setting mode 2004 (step S335), and advances the process to step S204. As a result, the mode is switched from the continuous scan mode to the sequential checking mode, and the process of the sequential checking mode (step S204) is performed.

On the other hand, when the sequential checking mode has not been received (step S334: No), the display control unit 202 determines whether to display a list screen of the list (step S336). In step S336, as is the screen illustrated in FIG. 9, when the “VIEW SHOPPING BASKET” button or the like is tapped, the display control unit 202 determines to display the list screen of the list.

When the list screen of the list is not displayed (step S336: No), the display control unit 202 returns the process to step S332. On the other hand, when displaying the list screen of the list (step S336: Yes), the display control unit 202 displays the list screen of the list on the terminal device 21 (step S337). The display control unit 202 determines whether a reading instruction has been received (step S338). When receiving the reading instruction (step S338: Yes), the display control unit 202 returns the process to step S331. As a result, a new reading screen in the continuous scan mode is displayed.

On the other hand, when the reading instruction has not been received (step S338: No), the settlement unit 206 determines whether the payment instruction has been received (step S339). In a case where the payment instruction has not been received (step S339: No), the registration unit 203 returns the process to step S332. In a case where the payment instruction has been received (step S339: Yes), the settlement unit 206 generates payment information (step S340).

Then, the settlement unit 206 determines whether the settlement instruction has been received (step S341). On the other hand, when the settlement instruction has not been received (step S341: No), the settlement unit 206 returns the process to step S341. In a case where the settlement instruction has been received (step S341: Yes), the settlement unit 206 makes the settlement (step S342). Then, the control system 20 returns the process. As a result, the control system 20 ends the series of processing.

The order of each step can be changed as appropriate. The order of step S332, step S334, and step S336 is not particularly limited. The order of step S338 and step S339 is not particularly limited. By storing the mode in the setting mode 2004, when a new transaction is started, the stored mode may be used without newly receiving the mode by the operation by the customer.

### <Operation Example of Terminal Device 21>

As described above, as in the control system 20, the terminal device 21 operates in the order illustrated in FIG. 14. Therefore, although a description of the entire operation example in the terminal device 21 is omitted, an operation example of each process will be described.

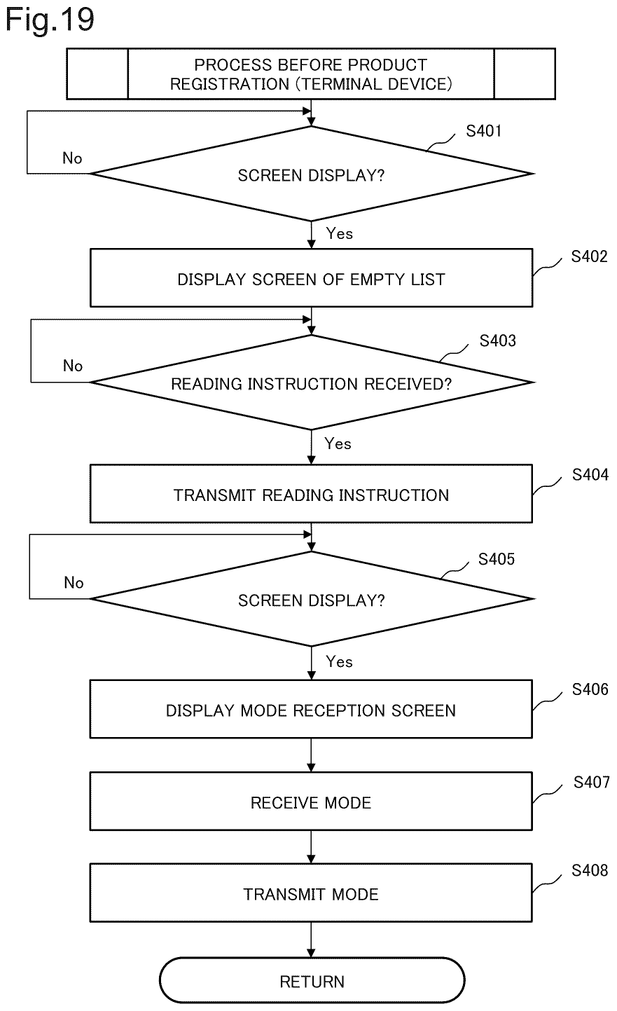

FIG. 19 is a flowchart illustrating an example of a specific processing procedure of the process (step S211) before product registration by the terminal device 21. The display unit 212 determines whether to display a new screen (step S401). When the screen is not displayed (step S401: No), the display unit 212 returns the process to step S401. That is, the display unit 212 is in a standby state of control by the display control unit 202. Also in the following description, in the process of determining whether to display a new screen, if No, the display unit 212 is in a standby state of control by the display control unit 202.

When the screen is displayed (step S401: Yes), the display unit 212 displays a list screen of the empty list (step S402).

Next, the operation reception unit 211 determines whether a reading instruction has been received (step S403). In step S403, when the “ADD PRODUCT” button or the like is tapped on the list screen, the operation reception unit 211 receives the reading instruction. When the reading instruction has not been received (step S403: No), the operation reception unit 211 returns the process to step S403. On the other hand, when a reading instruction is received (step S403: Yes), the operation reception unit 211 transmits the reading instruction to the control system 20 (step S404). As a result, the mode reception unit 201 of the control system 20 can receive the reading instruction by receiving the reading instruction.

Then, the display unit 212 determines whether to display a new screen (step S405). When the screen is not displayed (step S405: No), the display unit 212 returns the process to step S405.

When the screen is displayed (step S405: Yes), the display unit 212 displays a mode reception screen under the control of the display control unit 202 (step S406). Then, the operation reception unit 211 receives a mode (step S407). Then, the operation reception unit 211 transmits the received mode (step S408), and the process returns. As a result, the terminal device 21 ends the process before product registration and performs a process according to the received mode.

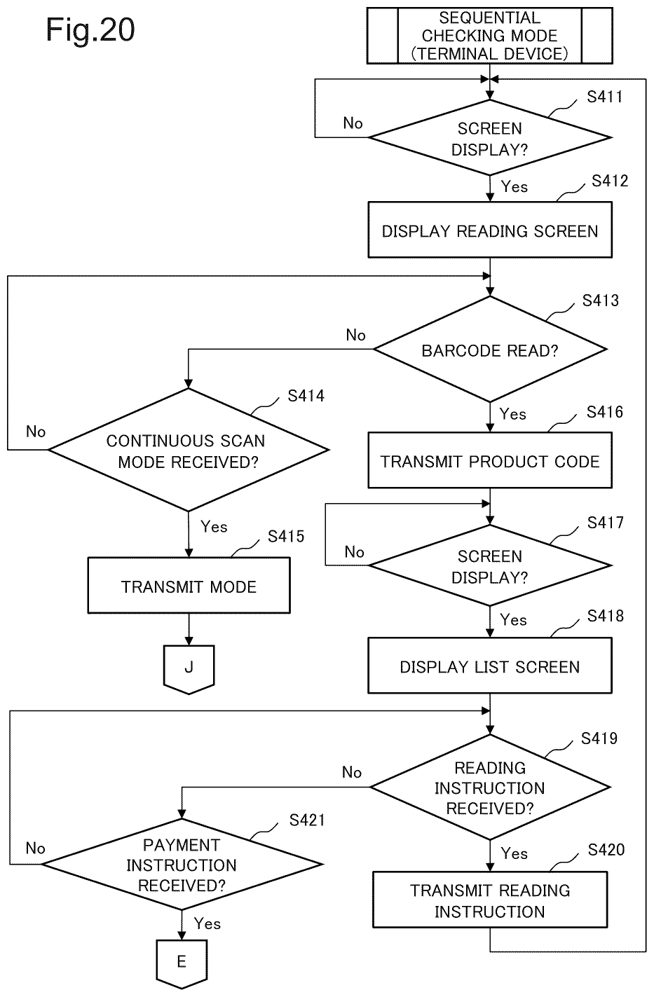

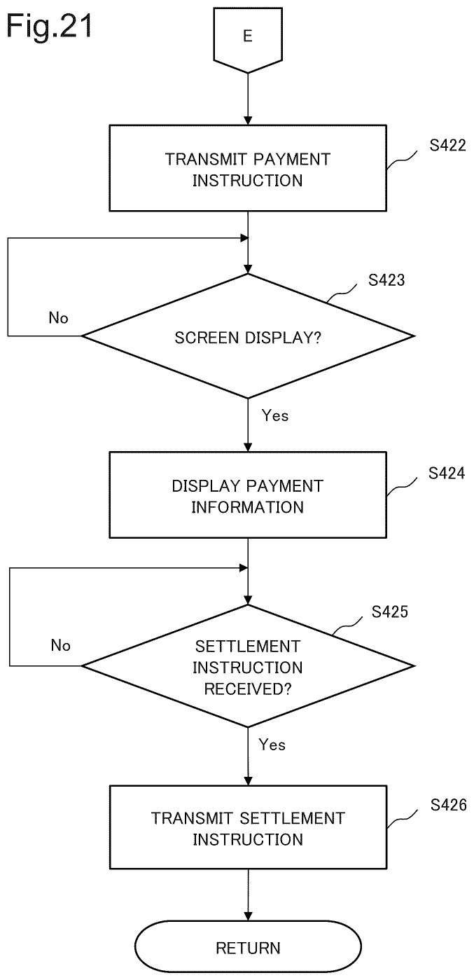

FIGS. 20 and 21 are flowcharts illustrating an example of a specific processing procedure of the process of the sequential checking mode (step S214) by the terminal device 21. The display unit 212 determines whether to display a new screen (step S411). When the screen is not displayed (step S411: No), the display unit 212 returns the process to step S411. When the screen is displayed (step S411: Yes), the display unit 212 displays the reading screen (step S412). The reading unit 213 determines whether the barcode has been read (step S413).

When reading the barcode (step S413: Yes), the reading unit 213 transmits the product code indicated by the barcode to the control system 20 (step S416).

When the barcode is not read (step S413: No), the operation reception unit 211 determines whether the continuous scan mode is received (step S414). In step S414, for example, when a button switchable to the continuous scan mode is tapped on the reading screen, the operation reception unit 211 receives the continuous scan mode. When the continuous scan mode has not been received (step S414: No), the operation reception unit 211 returns the process to step S413.

When the continuous scan mode is received (step S414: Yes), the operation reception unit 211 transmits the received mode (step S415) and advances the process to step S213. As a result, the process of the continuous scan mode is performed.

After step S415, the display unit 212 determines whether to display a new screen (step S417). When the screen is not displayed (step S417: No), the display unit 212 returns the process to step S417. When the screen is displayed (step S417: Yes), the display unit 212 displays the list screen under the control of the display control unit 202 (step S418).

The operation reception unit 211 determines whether a reading instruction has been received (step S419). For example, the operation reception unit 211 receives the reading instruction when the “ADD PRODUCT” button is tapped on the list screen. When receiving the reading instruction (step S419: Yes), the operation reception unit 211 transmits the reading instruction (step S420). After step S420, the display unit 212 returns the process to step S411. As a result, the display of the terminal device 21 is switched from the list screen to the reading screen.

On the other hand, when the reading instruction has not been received (step S419: No), the operation reception unit 211 determines whether a payment instruction has been received (step S421). When the payment instruction has not been received (step S421: No), the operation reception unit 211 returns the process to step S419.

When the payment instruction is received (step S421: Yes), the operation reception unit 211 transmits the payment instruction (step S422).

After step S422, the display unit 212 determines whether to display a new screen (step S423). When the screen is not displayed (step S423: No), the display unit 212 returns the process to step S417. In a case where the screen is displayed (step S423: Yes), the display unit 212 displays the payment information under the control of the display control unit 202 (step S424). The operation reception unit 211 determines whether a settlement instruction has been received (step S425). For example, when a button for confirming the settlement such as “SETTLEMENT” or “CONFIRMED” displayed on a screen including the payment information is tapped, the operation reception unit 211 determines that the settlement instruction has been received.

When the settlement instruction is received (step S425: No), the operation reception unit 211 returns the process to step S425. When the settlement instruction is received (step S425: Yes), the operation reception unit 211 transmits the settlement instruction (step S426), and the process returns. As a result, the terminal device 21 ends the series of processing.

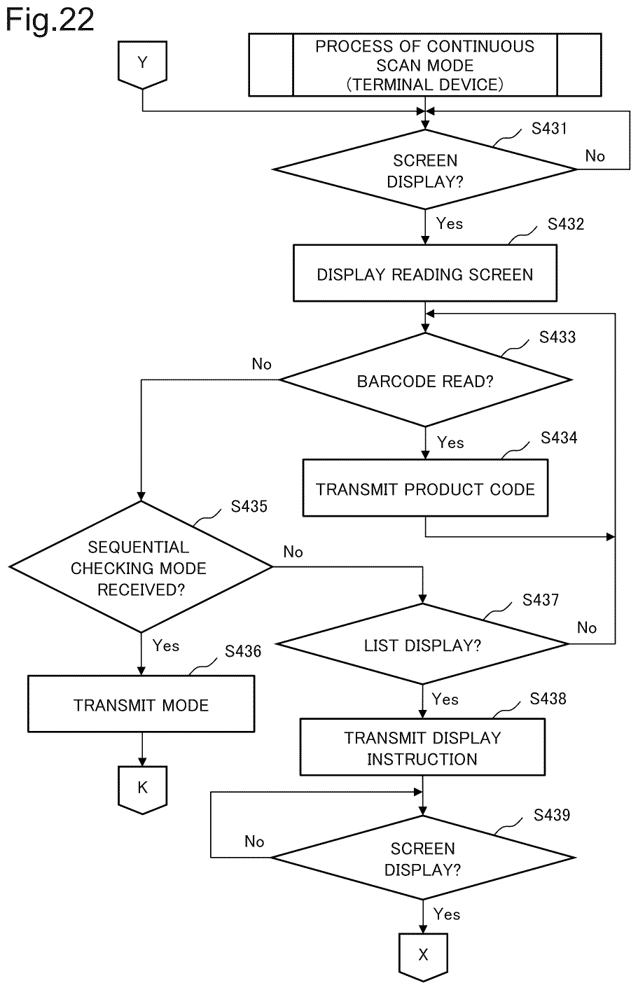

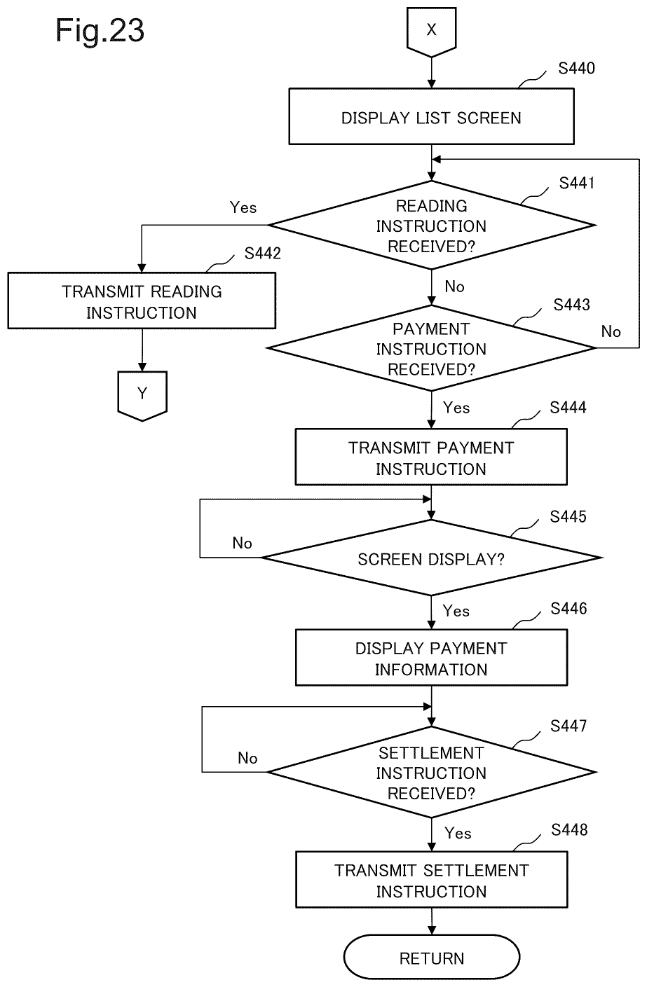

FIGS. 22 and 23 are flowcharts illustrating an example of a specific processing procedure of the process of the continuous scan mode (step S213) by the terminal device 21. The display unit 212 determines whether to display a new screen (step S431). When the screen is not displayed (step S431: No), the display unit 212 returns the process to step S431. When the screen is displayed (step S431: Yes), the display unit 212 displays the reading screen (step S432). Next, the reading unit 213 determines whether the barcode has been read (step S433).

When reading the barcode (step S433: Yes), the reading unit 213 transmits the product code indicated by the barcode to the control system 20 (step S434), and returns the process to step S431. Accordingly, a new reading screen can be displayed. After step S434, the process may return to step S433. As a result, the same reading screen remains displayed.

When the barcode is not read (step S433: No), the operation reception unit 211 determines whether the sequential checking mode has been received (step S435). In step S435, for example, when a button switchable to the sequential checking mode is tapped on the reading screen, the operation reception unit 211 receives the sequential checking mode. When the sequential checking mode is received (step S435: Yes), the operation reception unit 211 transmits the mode (step S436) and advances the process to step S214. As a result, the process of the sequential checking mode is performed.

When the sequential checking mode has not been received (step S435: No), the operation reception unit 211 determines whether a list display instruction has been received (step S437). When the list display instruction has not been received (step S437: No), the reading unit 213 returns the process to step S433. When receiving the list display instruction (step S437: Yes), the operation reception unit 211 transmits the list display instruction to the control system 20 (step S438).

Then, the display unit 212 determines whether to display a new screen (step S439). When the screen is not displayed (step S439: No), the display unit 212 returns the process to step S439. When the screen is displayed (step S439: Yes), the display unit 212 displays a list screen (step S440).

The operation reception unit 211 determines whether a reading instruction has been received (step S441). For example, the operation reception unit 211 receives the reading instruction when the “ADD PRODUCT” button is tapped on the list screen. When receiving the reading instruction (step S441: Yes), the operation reception unit 211 transmits the reading instruction (step S442). After step S442, the display unit 212 returns the process to step S431. As a result, the display of the terminal device 21 is switched from the list screen to the reading screen.

When the reading instruction has not been received (step S441: No), the operation reception unit 211 determines whether a payment instruction has been received (step S443). When the payment instruction has not been received (step S443: No), the operation reception unit 211 returns the process to step S441.

When the payment instruction is received (step S443: Yes), the operation reception unit 211 transmits the payment instruction (step S444).

After step S444, the display unit 212 determines whether to display a new screen (step S445). When the screen is not displayed (step S445: No), the display unit 212 returns the process to step S417. When the screen is displayed (step S445: Yes), the display unit 212 displays the payment information under the control of the display control unit 202 (step S446). The operation reception unit 211 determines whether a settlement instruction has been received (step S447).

When the settlement instruction is received (step S447: No), the operation reception unit 211 returns the process to step S447. When the settlement instruction is received (step S447: Yes), the operation reception unit 211 transmits the settlement instruction (step S448), and returns the process. As a result, the terminal device 21 ends the series of processing.

<Operation Example of Process of Determining Whether there is Suspicion>

Next, an operation example of the process in which the control system 20 determines whether the operation is suspicious in the continuous scan mode will be described. An operation example of each determination method will be described. An example in which the mode is switched to the sequential checking mode in a case where it is determined that there is suspicious in the continuous scan mode will be described.

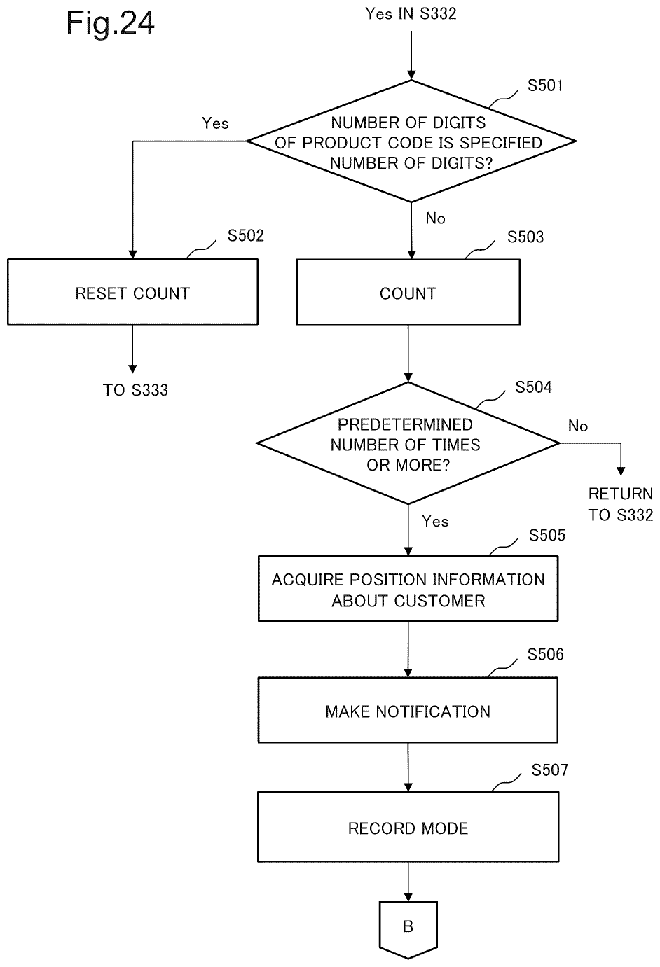

FIG. 24 is a flowchart illustrating an example of a specific processing procedure of the processing example 1 of the control system 20 determining whether the action is suspicious. The processing example 1 is the determination example 1 in which it is determined whether the action is suspicious according to the number of digits of the product code.

For example, when the product code is received (step S332: Yes), the determination unit 204 determines whether the number of digits of the product code is a specified number of digits (step S501).

When the number of digits is not the specified number of digits (step S501: No), the determination unit 204 counts the number of times it is determined that the number of digits of the read product code is not the specified number of digits (step S503). Next, the determination unit 204 determines whether the number of times is equal to or more than a predetermined number of times (step S504). In a case where the number of times is equal to or more than the predetermined number of times, the determination unit 204 determines that the action is suspicious. When the number of times is less than the predetermined number of times (step S504: No), the registration unit 203 returns the process to step S332.

When the number of times is equal to or more than the predetermined number of times (step S504: Yes), the position information acquisition unit 205 acquires the position information about the customer (step S505). In step S505, the position information acquisition unit 205 acquires the position information about the terminal device 21 as the position information about the customer by positioning the terminal device 21 using the beacon device 22 or the like. Next, the notification unit 207 notifies the store clerk of the position information about the customer and the information indicating that the action is suspicious (step S506). In step S506, for example, the notification unit 207 makes a notification to the terminal device of the store clerk.

Then, the mode reception unit 201 records the sequential checking mode as a mode (step S507), and advances the process to step S204. As a result, the mode is switched to the sequential checking mode.

On the other hand, when the number of digits is the prescribed number of digits (step S501: Yes), the determination unit 204 resets the counted number of times (step S502), and returns the process to step S333.

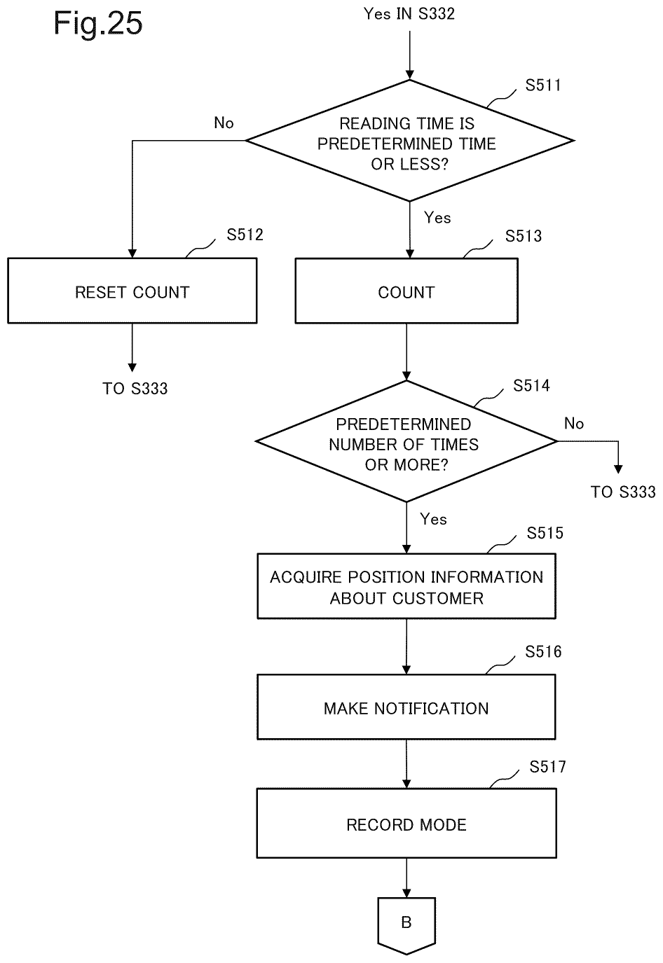

FIG. 25 is a flowchart illustrating an example of a specific processing procedure of the processing example 2 of the control system 20 determining whether the action is suspicious. The processing example 2 is the determination example 2 of determining whether the action is suspicious based on whether the reading time is short.

For example, when the product code is received (step S332: Yes), the determination unit 204 determines whether the reading time is equal to or shorter than a predetermined time (step S511).

When the reading time is equal to or shorter than the predetermined time (step S511: Yes), the determination unit 204 counts the number of times the reading time is short (step S513). The determination unit 204 determines whether the number of times is equal to or more than a predetermined number of times (step S514). In a case where the number of times is equal to or more than the predetermined number of times, the determination unit 204 determines that the action is suspicious.

When the number of times is equal to or more than the predetermined number of times (step S514: Yes), the position information acquisition unit 205 acquires the position information about the customer (step S515). In step S515, the position information acquisition unit 205 acquires the position information about the terminal device 21 as the position information about the customer by positioning the terminal device 21 using the beacon device 22 or the like. Next, the notification unit 207 notifies the store clerk of the position information about the customer and the information indicating that the action is suspicious (step S516). In step S516, for example, the notification unit 207 makes a notification to the terminal device of the store clerk.

Then, the mode reception unit 201 records the sequential checking mode as a mode in the setting mode 2004 (step S517), and advances the process to step S204. As a result, the mode is switched to the sequential checking mode.

When the reading time is longer than the predetermined time (step S511: No), the determination unit 204 resets the counted number of times (step S512), and returns the process to step S333. In a case where the number of times is less than the predetermined number of times (step S514: No), the process returns to step S333.

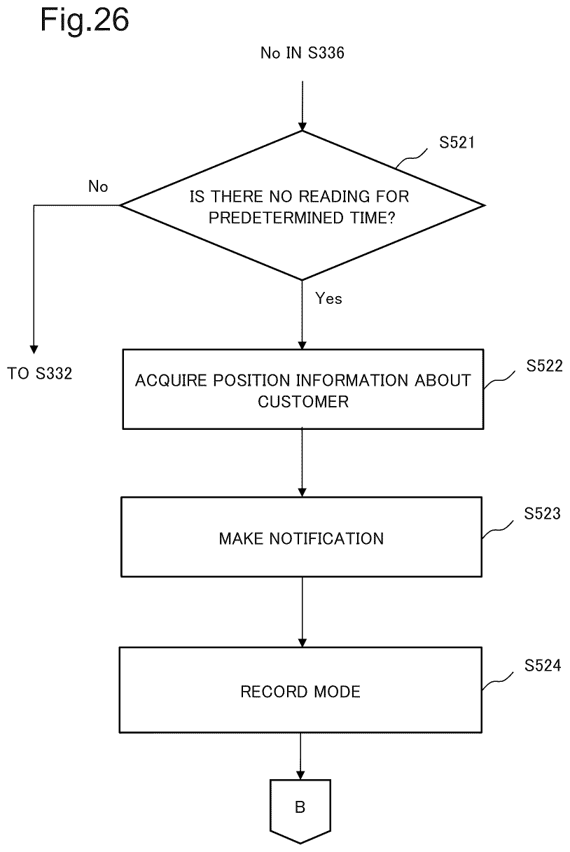

FIG. 26 is a flowchart illustrating an example of a specific processing procedure of the processing example 3 of the control system 20 determining whether the action is suspicious. The processing example 3 is the determination example 3 in which it is determined whether the action is suspicious based on whether there is no reading for a predetermined time. When the list is not displayed (step S336: No), the determination unit 204 determines whether there is reading within a predetermined time (step S521). When there is no reading for a predetermined time, the determination unit 204 determines that the action is suspicious.

On the other hand, when there is no reading for the predetermined time (step S521: No), the position information acquisition unit 205 acquires the position information about the customer (step S522). Then, in step S522, for the notification unit 207, the position information acquisition unit 205 acquires the position information about the terminal device 21 as the position information about the customer by positioning the terminal device 21 using the beacon device 22 or the like. Next, the notification unit 207 notifies the store clerk of the position information about the customer and the information indicating that the action is suspicious (step S523). In step S523, for example, the notification unit 207 makes a notification to the terminal device of the store clerk.

Then, the mode reception unit 201 records the sequential checking mode as a mode (step S524), and advances the process to step S204. As a result, the mode is switched to the sequential checking mode.

On the other hand, when there is reading within the predetermined time (step S521: Yes), the registration unit 203 advances the process to step S332.

When the sequential checking mode is not received (step S334: No), step S521 may be started. When step S521 is performed after the sequential checking mode is not received (step S334: No), if No in step S521, the process may proceed to step S336. After the case where the product code is not received (step S332: No), step S521 may be started. When step S521 is performed after the case where the product code is not received (step S332: No), if No in step S521, the process may proceed to step S334.

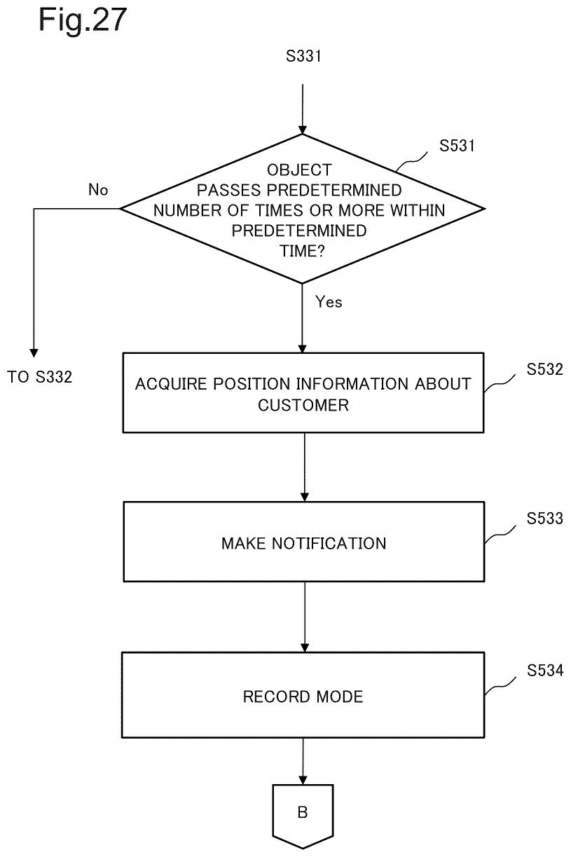

FIG. 27 is a flowchart illustrating an example of a specific processing procedure of the processing example 4 of the control system 20 determining whether the action is suspicious. After step S331, the determination unit 204 determines whether an object has passed within the angle of view of the imaging device of the terminal device 21 equal to or more than a predetermined number of times within a predetermined time (step S531). The determination unit 204 determines that the action is suspicious when the object has passed equal to or more than the predetermined number of times within the predetermined time.

When the object has not passed through the angle of view of the imaging device for equal to or more than the predetermined number of times within the predetermined time (step S531: No), the registration unit 203 advances the process to step S332.

On the other hand, when the object has passed through the angle of view of the imaging device equal to or more than the predetermined number of times within the predetermined time (step S531: Yes), the position information acquisition unit 205 acquires the position information about the customer (step S532). Then, in step S522, for the notification unit 207, the position information acquisition unit 205 acquires the position information about the terminal device 21 as the position information about the customer by positioning the terminal device 21 using the beacon device 22 or the like. Next, the notification unit 207 notifies the store clerk of the position information about the customer and the information indicating that the action is suspicious (step S533). In step S533, for example, the notification unit 207 makes a notification to the terminal device of the store clerk.

Then, the mode reception unit 201 records the sequential checking mode as a mode (step S534), and advances the process to step S204. As a result, the mode is switched to the sequential checking mode.

As described above, in the second example embodiment, in the continuous scan mode, the control system 20 displays the list screen when receiving a list display instruction on the reading screen, and displays the reading screen when receiving a reading instruction on the list screen. As described above, even in the continuously scannable mode, the customer can check the list at a desired timing. As a result, it is possible to improve the convenience of the customer at the time of shopping.

When the product code is read in the continuous scan mode, the control system 20 displays, on the reading screen, information about the product identified by the read product code. As a result, the customer can check the name, price, and the like of the product identified by the newly read product code. As a result, it is possible to improve the convenience of the customer at the time of shopping.

The control system 20 receives a mode before starting product registration. Accordingly, the customer can select a mode according to his/her preference before starting the scan shopping. As a result, it is possible to improve the convenience of the customer at the time of shopping.

The control system 20 receives the continuous scan mode during display of the reading screen in the sequential checking mode. As a result, the customer can easily switch from the sequential checking mode to the continuous scan mode.

In the continuous scan mode, the control system 20 receives the sequential checking mode while the reading screen is being displayed. As a result, the customer can easily switch from the continuous scan mode to the sequential checking mode. As a result, it is possible to improve the convenience of the customer at the time of shopping.

The control system 20 determines whether the action by the customer when the reading screen is displayed on the terminal device 21 is suspicious in the continuous scan mode. Specifically, for example, as an example of determining whether the action is suspicious, the control system 20 may determine whether the action by the customer is suspicious based on whether the newly read product code has a predetermined number of digits. Alternatively, as another example of determining whether the action by the customer is suspicious, the control system 20 determines whether the action by the customer is suspicious based on whether it is continuously determined a predetermined number of times that the newly read product code does not have a predetermined number of digits. Alternatively, as another example of determining whether the action is suspicious, the control system 20 determines whether the action by the customer is suspicious based on whether the time required to newly read the product code is within a predetermined time. Alternatively, as another example of determining whether the action is suspicious, the control system 20 determines whether the action by the customer is suspicious based on whether the new product code is read for equal to or more than a predetermined time. Alternatively, as another example of determining whether the action is suspicious, in a case where the product code is read by imaging the product code by the imaging device in the terminal device 21, the control system 20 determines whether the action by the customer is suspicious based on whether passage of the object by the imaging device is confirmed. Accordingly, it is possible to monitor a suspicious action by the customer in the scan shopping.

When it is determined that the action by the customer is suspicious, the control system 20 switches to the sequential checking mode. In this manner, by switching to the sequential checking mode, suspicious action can be suppressed.

When the action by the customer is determined to be suspicious, the control system 20 notifies the store clerk that the action by the customer is suspicious. At the time of this notification, the control system 20 notifies the store clerk of the position information about the customer and that the action by the customer is suspicious. As a result, the store clerk can easily grasp the customer performing the suspicious action.

The second example embodiment is not limited to the above-described example, and may be modified and used, and modifications will be described below.

### <First Modification>

For example, the present invention is not limited to the example in which the product code is read from the barcode attached to the product, and the RFID reader of the terminal device 21 may read the product code from the RFID attached to the product.

### <Second Modification>

In the second example embodiment, an example in which the determination of whether the operation is suspicious is used in the continuous scan mode is described, but the determination is not particularly limited. For example, the determination of whether the operation is suspicious may be used in the sequential checking mode, or may be used in general scan shopping. For example, in the sequential checking mode, when it is determined that the operation is suspicious, the display control unit 202 may display, on the reading screen, caution to the customer, an inquiry to the customer, or the like.

### <Third Modification>

In the second example embodiment, an example in which a button for giving a settlement instruction such as a “PAYMENT” button is included in the list screen is described, but the present invention is not limited thereto, and such a button may be included in the reading screen. Alternatively, when reading is not performed on the reading screen for a predetermined time, the display control unit 202 may display a screen including this button in such a way as to be superimposed on the reading screen.

The description of each example embodiment and each modification is ended. The example embodiments and the modifications described in the example embodiments may be used in combination.

As described above, the example embodiments and the modifications are not limited to the examples described above, and various modifications can be made. The configuration of the control system in each example embodiment is not particularly limited. The control system may be achieved by one device, or may be achieved by devices different for each piece of information or function. For example, one terminal device may include at least part of the function unit of the control system 20 described in the second example embodiment. The one terminal device may be, for example, the terminal device 21 of the customer. For example, the terminal device 21 of the customer may have a function unit related to a specific application program. For example, the terminal device may include the mode reception unit 201, the display control unit 202, the registration unit 203, the determination unit 204, the position information acquisition unit 205, and the notification unit 207, and the server may include the settlement unit 206. The function unit included in the terminal device 21 are not limited to this example.

The control system may include several servers. For example, a function unit that controls display of a terminal device such as a display control unit may be configured by an application server, a function such as a registration unit may be configured by a POS server, and a DB or the like may be configured by a database server. The determination unit 204 may be configured by the terminal device 21 of the customer, and each of the other function units may be achieved by a server.

Various types of information and DBs may be stored in a storage means of one device such as a database server, or may be distributed and stored in a plurality of different devices. Therefore, the various types of information and the DBs may be acquired from another device via a communication network or the like, or may be stored in the storage means of the control system in each example embodiment.

The control system in each example embodiment may be configured to include some function units.

A transmission/reception target may be information itself or an identifier representing information between devices such as the terminal device and the control system described in each example embodiment and modification.

In each example embodiment and modification, each piece of information may include part of the information described above. Each piece of information and DBs may include information other than the above-described information. Each piece of information or DBs may be divided into a plurality of pieces of information in more detail. As described above, a method of achieving each piece of information and DB is not particularly limited.

In each screen, the position, color, and size of each item such as a button, an input field, and a display field are not particularly limited. In each screen, a button, an information display field, an input field, and the like (not illustrated) may be added. The background color of the screen and the like may be changed.

For example, in each example embodiment, the process of generating information or the like of a screen to be displayed on a display device of a terminal device of a customer may be performed by a control system or may be performed by a terminal device of a customer.

### (Computer Device)

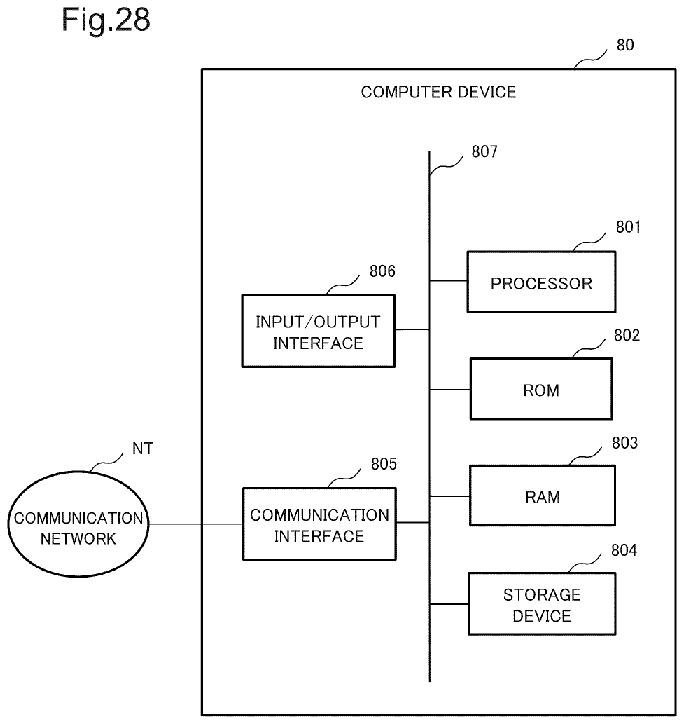

Next, a hardware configuration example in a case where each device such as the control system and the terminal device described in each example embodiment is implemented by a computer device will be described. FIG. 28 is an explanatory diagram illustrating a hardware configuration example of a computer device. For example, some or all of the devices can be achieved by using an any combination of a computer device 80 and the program as illustrated in FIG. 28, for example.

The computer device 80 includes, for example, a processor 801, a read only memory (ROM) 802, a random access memory (RAM) 803, a storage device 804, a communication interface 805, and an input/output interface 806. The components are connected via a bus 807.

The processor 801 controls the entire computer device 80. Examples of the processor 801 include a central processing unit (CPU), a digital signal processor (DSP), and the like. The number of processors 801 may be plural. The computer device 80 includes a ROM 802, a RAM 803, a storage device 804, and the like as storage units. Examples of the storage device 804 include a semiconductor memory such as a flash memory, a hard disk drive (HDD), a solid state drive (SSD), and the like. For example, the storage device 804 stores an operating system (OS) program, an application program, a program according to each example embodiment, and the like. Alternatively, the ROM 802 stores an application program, a program according to each example embodiment, and the like. Then, the RAM 803 is used as a work area of the processor 801.

The processor 801 loads a program stored in the storage device 804, the ROM 802, or the like. Then, the processor 801 executes each process or each instruction coded in the program. The processor 801 may download various programs via the communication network NT. The processor 801 functions as part or all of the computer device 80. Then, the processor 801 may execute processes or instructions in the flowchart illustrated based on the program.

The communication interface 805 is connected to the communication network NT such as a local area network (LAN) or a wide area network (WAN) through a wireless or wired communication line. The communication network NT may include a plurality of communication networks. As a result, the computer device 80 is connected to an external device or an external computer device 80 via the communication network NT. The communication interface 805 manages an interface between the communication network NT and the inside of the computer device 80. Then, the communication interface 805 controls an input/output of data from an external device or an external computer device.

The input/output interface 806 is connected to at least one of an input device, an output device, and an input/output device. The connection method may be wireless or wired. Examples of the input device include a keyboard, a mouse, and a microphone. Examples of the output device include a display device, a lighting device, and a speaker that is an audio output device that outputs a voice. Examples of the input/output device include a touch panel display. The input device, the output device, the input/output device, and the like may be built in the computer device 80 or may be externally attached.

The hardware configuration of the computer device 80 is an example. The computer device 80 may have some components illustrated in FIG. 28. The computer device 80 may have components other than those illustrated in FIG. 28. For example, the computer device 80 may include a drive device or the like. Then, the processor 801 may read a program or data stored in a recording medium attached to a drive device or the like into the RAM 803. Examples of the non-transitory tangible recording medium include an optical disk, a flexible disk, a magnetic optical disk, and a Universal Serial Bus (USB) memory. As described above, for example, the computer device 80 may include an input device such as a keyboard and a mouse. The computer device 80 may include an output device such as a display. The computer device 80 may include an input device, an output device, and an input/output device. The computer device 80 may include an imaging device and various reading devices.

The computer device 80 may include various sensors (not illustrated). The type of the sensor is not particularly limited. Examples of the sensor include an acceleration sensor, a gyro sensor, a magnetic sensor, a global positioning system (GPS), and a sensor. Examples of the sensor include a fingerprint sensor, light, detection and ranging (LiDAR), a proximity sensor, and an ambient optical sensor.

The description of the hardware configuration of each device ends. There are various modifications in a method of achieving each device. For example, the control system may be achieved by an any combination of a computer device and a program different for each component. A plurality of components included in each device may be achieved by any combination of one computer device and a program.

Part or all of each component of each device may be achieved by an application specific circuit. Part or all of the control system may be achieved by a general-purpose circuit including a processor such as a field programmable gate array (FPGA). Part or all of the control system may be achieved by a combination of an application specific circuit, a general-purpose circuit, and the like. The circuit may be a single integrated circuit. Alternatively, the circuit may be divided into a plurality of integrated circuits. The plurality of integrated circuits may be configured by being connected via a bus or the like.

When part or all of each component of each device is achieved by a plurality of computer devices, circuits, and the like, the plurality of computer devices, circuits, and the like may be disposed in a centralized manner or in a distributed manner.

The control method described in each example embodiment is implemented by the control system executing the control method. The control method is implemented by a computer device such as a terminal device or a server executing a program prepared in advance. The program described in each example embodiment is recorded in a computer device-readable recording medium such as an HDD, an SSD, a flexible disk, an optical disk, a flexible disk, a magnetic optical disk, or a USB memory. Then, the program is executed by being read from the recording medium by the computer device. The program may be distributed via the communication network NT.

Each component of the control system in each example embodiment described above may be achieved in hardware as in a computer device. Alternatively, each component may be achieved by a computer device or firmware based on program control.

While the present disclosure has been particularly shown and described with reference to each of example embodiments, the present disclosure is not limited to these example embodiments. The configurations and details of the present disclosure may include example embodiments to which various changes that can be grasped by those of ordinary skill in the art without departing from the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

Some or all of the above example embodiments can also be described as the following Supplementary Notes. However, some or all of the above example embodiments are not limited to the following.

### (Supplementary Note 1)

A control system that controls a screen to be displayed by a terminal device, the control system including:
a registration means configured to register, when identification information is read on a reading screen capable of reading the identification information about a product by an operation by a customer on the terminal device, the product indicated by identification information in a list;
a mode reception means configured to receive one of a sequential checking mode in which a list screen of the list is displayed when the identification information is read and a continuous mode in which the reading screen is displayed when the identification information is read; and
a display control means configured to display a screen related to the received mode on the terminal device.

### (Supplementary Note 2)

The control system according to Supplementary Note 1, wherein
in the continuous mode, the display control means displays the list when receiving a display instruction of the list on the reading screen screen and displays the reading screen when receiving a reading instruction on the list screen.

### (Supplementary Note 3)

The control system according to Supplementary Note 1 or 2, wherein
in the continuous mode, the display control means displays information about the product identified by the read identification information on the reading screen when the identification information is read.

### (Supplementary Note 4)

The control system according to any one of Supplementary Notes 1 to 3, wherein
the mode reception means receives the mode by an operation by the customer.

### (Supplementary Note 5)

The control system according to Supplementary Note 4, wherein
the mode reception means receives the mode before starting product registration.

### (Supplementary Note 6)

The control system according to Supplementary Note 4, wherein
the mode reception means receives the continuous mode while the reading screen is being displayed in the sequential checking mode.

### (Supplementary Note 7)

The control system according to Supplementary Note 4, wherein
the mode reception means receives the sequential checking mode while the reading screen is being displayed in the continuous mode.

### (Supplementary Note 8)

The control system according to any one of Supplementary Notes 1 to 7, further including
a determination means configured to determine, in the continuous mode, whether an action by the customer when the reading screen is displayed on the terminal device is suspicious, wherein
the mode reception means receives the sequential checking mode when it is determined, in the continuous mode, that the action by the customer is suspicious.

### (Supplementary Note 9)

The control system according to any one of Supplementary Notes 1 to 7, further including:
a determination means configured to determine, in the continuous mode, whether an action by the customer when the reading screen is displayed on the terminal device is suspicious; and
a notification means configured to notify a store clerk that the action by the customer is suspicious when it is determined, in the continuous mode, that the action by the customer is suspicious.

### (Supplementary Note 10)

The control system according to Supplementary Note 9, further including
a position information acquisition means configured to acquire position information about the customer when it is determined that an action by the customer is suspicious, wherein
the notification means notifies the store clerk of the acquired position information and that the action by the customer is suspicious.

### (Supplementary Note 11)

The control system according to any one of Supplementary Notes 8 to 10, wherein
the identification information is a code, and
the determination means determines whether an action by the customer is suspicious based on whether the newly read code has a predetermined number of digits.

### (Supplementary Note 12)

The control system according to Supplementary Note 11, wherein
the determination means determines whether an action by the customer is suspicious based on whether it is continuously determined a predetermined number of times that the newly read code does not have a predetermined number of digits.

### (Supplementary Note 13)

The control system according to any one of Supplementary Notes 8 to 10, wherein
the determination means determines whether an action by the customer is suspicious based on whether a time required to newly read the identification information is within a predetermined time.

### (Supplementary Note 14)

The control system according to any one of Supplementary Notes 8 to 10, wherein
the determination means determines whether an action by the customer is suspicious based on whether the new identification information is read for a predetermined time or more.

### (Supplementary Note 15)

The control system according to any one of Supplementary Notes 8 to 10, wherein,
when the terminal device reads the identification information by imaging the identification information with an imaging device,
the determination means determines whether an action by the customer is suspicious based on whether passage of an object is confirmed by the imaging device.

### (Supplementary Note 16)

The control system according to any one of Supplementary Notes 1 to 15, wherein
the reading screen related to the received mode includes information indicating the received mode.

### (Supplementary Note 17)

A control method of controlling a screen to be displayed by a terminal device, the control method including:
registering, when identification information is read on a reading screen capable of reading the identification information about a product by an operation by a customer on the terminal device, the product indicated by identification information in a list; receiving one of a sequential checking mode in which a list screen of the list is displayed when the identification information is read and a continuous mode in which the reading screen is displayed when the identification information is read; and
displaying a screen related to the received mode on the terminal device.

### (Supplementary Note 18)

A non-transitory computer-readable recording medium that records a program for causing a computer controlling a screen to be displayed by a terminal device to execute processing including:
registering, when identification information is read on a reading screen capable of reading the identification information about a product by an operation by a customer on the terminal device, the product indicated by identification information in a list: receiving one of a sequential checking mode in which a list screen of the list is displayed when the identification information is read and a continuous mode in which the reading screen is displayed when the identification information is read; and
displaying a screen related to the received mode on the terminal device.

### (Supplementary Note 19)

A program for causing a computer controlling a screen to be displayed by a terminal device to execute processing including:
registering, when identification information is read on a reading screen capable of reading the identification information about a product by an operation by a customer on the terminal device, the product indicated by identification information in a list: receiving one of a sequential checking mode in which a list screen of the list is displayed when the identification information is read and a continuous mode in which the reading screen is displayed when the identification information is read;
displaying a screen related to the received mode on the terminal device; and
registering, when the identification information is newly read on the reading screen, the identification information in the list.

### REFERENCE SIGNS LIST

10, 20 control system
21 terminal device
22 device
80 computer device
101, 201 mode reception unit
102, 202 display control unit
103, 203 registration unit
204 determination unit
205 position information acquisition unit
206 settlement unit
207 notification unit
211 operation reception unit
212 display unit
213 reading unit
801 processor
802 ROM
803 RAM
804 storage device
805 communication interface
806 input/output interface
807 bus
d001 screen
d101 reading screen
d102 list screen
d103 reading screen
d201 reading screen
d202 list screen
d203 reading screen
d204 reading screen
d301 reading screen
d302 reading screen
d401 screen
2001 product DB
2002 list DB
2003 customer DB
2004 setting mode
NT communication network

What is claimed is:

1. A control system that controls a screen to be displayed by a terminal device, the control system comprising:
a memory storing instructions; and
at least one processor configured to execute the instructions to:
register, when identification information is read on a reading screen capable of reading the identification information about a product by an operation by a customer on the terminal device, the product indicated by identification information in a list;
receive one of a sequential checking mode in which a list screen of the list is displayed when the identification information is read and a continuous mode in which the reading screen is displayed when the identification information is read; and
display a screen related to the received mode on the terminal device.

2. The control system according to claim 1, wherein the at least one processor is further configured to execute the instructions to:
in the continuous mode, display the list screen when receiving a display instruction of the list on the reading screen and display the reading screen when receiving a reading instruction on the list screen.

3. The control system according to claim 1, wherein the at least one processor is further configured to execute the instructions to:
in the continuous mode, display information about the product identified by the read identification information on the reading screen when the identification information is read.

4. The control system according to claim 1, wherein the at least one processor is further configured to execute the instructions to:
receive the mode by an operation by the customer.

5. The control system according to claim 4, wherein the at least one processor is further configured to execute the instructions to:
receive the mode before starting product registration.

6. The control system according to claim 4, wherein the at least one processor is further configured to execute the instructions to:
receive the continuous mode while the reading screen is being displayed in the sequential checking mode.

7. The control system according to claim 4, wherein the at least one processor is further configured to execute the instructions to:
receive the sequential checking mode while the reading screen is being displayed in the continuous mode.

8. The control system according to claim 1, wherein the at least one processor is further configured to execute the instructions to:
determine, in the continuous mode, whether an action by the customer when the reading screen is displayed on the terminal device is suspicious; and
receive the sequential checking mode when it is determined, in the continuous mode, that the action by the customer is suspicious.

9. The control system according to claim 1, wherein the at least one processor is further configured to execute the instructions to:
determine, in the continuous mode, whether an action by the customer when the reading screen is displayed on the terminal device is suspicious; and
notify a store clerk that the action by the customer is suspicious when it is determined, in the continuous mode, that the action by the customer is suspicious.

10. The control system according to claim 9, wherein the at least one processor is further configured to execute the instructions to:
acquire position information about the customer when it is determined that an action by the customer is suspicious; and
notify the store clerk of the acquired position information and that the action by the customer is suspicious.

11. The control system according to claim 8, wherein
the identification information is a code, and wherein the at least one processor is further configured to execute the instructions to:
determine whether an action by the customer is suspicious based on whether the newly read code has a predetermined number of digits.

12. The control system according to claim 11, wherein the at least one processor is further configured to execute the instructions to:
determine whether an action by the customer is suspicious based on whether it is continuously determined a predetermined number of times that the newly read code does not have a predetermined number of digits.

13. The control system according to claim 8, wherein the at least one processor is further configured to execute the instructions to:
determine whether an action by the customer is suspicious based on whether a time required to newly read the identification information is within a predetermined time.

14. The control system according to claim 8, wherein the at least one processor is further configured to execute the instructions to:
determine whether an action by the customer is suspicious based on whether the new identification information is read for a predetermined time or more.

15. The control system according to claim 8, wherein the at least one processor is further configured to execute the instructions to:
when the terminal device reads the identification information by imaging the identification information with an imaging device,
determine whether an action by the customer is suspicious based on whether passage of an object is confirmed by the imaging device.

16. The control system according to claim 1, wherein
the reading screen related to the received mode includes information indicating the received mode.

17. A control method of controlling a screen to be displayed by a terminal device, the control method comprising:
registering, when identification information is read on a reading screen capable of reading the identification information about a product by an operation by a customer on the terminal device, the product indicated by identification information in a list; receiving one of a sequential checking mode in which a list screen of the list is displayed when the identification information is read and a continuous mode in which the reading screen is displayed when the identification information is read; and
displaying a screen related to the received mode on the terminal device.

18. A non-transitory computer-readable recording medium that records a program for causing a computer controlling a screen to be displayed by a terminal device to execute processing comprising:
registering, when identification information is read on a reading screen capable of reading the identification information about a product by an operation by a customer on the terminal device, the product indicated by identification information in a list; receiving one of a sequential checking mode in which a list screen of the list is displayed when the identification information is read and a continuous mode in which the reading screen is displayed when the identification information is read; and
displaying a screen related to the received mode on the terminal device.
